(19) United States
(12) Patent Application Publication
(10) Pub. No.: US 2026/0162206 A1
(43) Pub. Date: Jun. 11, 2026

(54) PARALLEL THREAD MEMORY ACCESS FOR GRAPHICS PROCESSING

(71) Applicant: QUALCOMM Incorporated, San Diego, CA (US)

(72) Inventors: Yun LI, San Jose, CA (US); Fei XU, San Jose, CA (US); Hu YI, San Diego, CA (US); Suvam CHATTERJEE, San Diego, CA (US); Sparsh SINGHAI, San Diego, CA (US); Fengyu YI, Sunnyvale, CA (US); Jing HAN, San Jose, CA (US); Li SHEN, San Diego, CA (US); Swathi NETHAJI, San Jose, CA (US); Srikanth VADANAPARTHI, San Diego, CA (US)

(21) Appl. No.: 18/976,275

(22) Filed: Dec. 10, 2024

(51) Int. Cl. G06T 1/20; G06T 1/60

(52) U.S. Cl. CPC G06T 1/20; G06T 1/60

(57) ABSTRACT

Aspects presented herein relate to methods and devices for graphics processing including an apparatus, e.g., a graphics processor. The apparatus may allocate a memory location in a plurality of memory locations for data for each of a plurality of threads. The apparatus may also align the data for each of the plurality of threads with the allocated memory location if the data is not aligned with the allocated memory location; or refrain from aligning the data for each of the plurality of threads with the allocated memory location if the data is aligned with the allocated memory location. Further, the apparatus may output an indication of the aligned data for each of the plurality of threads or the refrained from aligned data for each of the plurality of threads.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor or display processing unit (DPU).

A graphics processor of a device may be configured to perform the processes in a graphics processing pipeline. Further, graphics processors may be utilized to perform graphics rendering. However, there has developed an increased need for improved rendering in graphics processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processor, a graphics processing unit (GPU), a central processing unit (CPU), or any apparatus that may perform for graphics processing. The apparatus may output a request for data for each of a plurality of threads associated with graphics processing, where an allocation of a memory location for the data for each of the plurality of threads is based on the request. The apparatus may also obtain, based on the request, an indication of the data for each of the plurality of threads, where each of the plurality of threads includes corresponding data. The apparatus may also adjust a data size for the data for each of the plurality of threads to a uniform data size, and where allocating a memory location in a plurality of memory locations for the data for each of the plurality of threads comprises: allocating, based on the uniform data size, the memory location in the plurality of memory locations for the data for each of the plurality of threads. Additionally, the apparatus may identify an address for each of a plurality of cache banks; and determine whether an address for each cache line for at least one first thread in the plurality of threads is equivalent to an address for each cache line for at least one second thread for each of the plurality of cache banks. The apparatus may also coalesce the data for the at least one first thread and the at least one second thread into a same cache line if the address for each cache line for the at least one first thread is equivalent to the address for each cache line for the at least one second thread for each of the plurality of cache banks. Moreover, the apparatus may allocate a memory location in a plurality of memory locations for data for each of a plurality of threads. The apparatus may also multiplex the data for each of the plurality of threads between a memory data layout for the plurality of memory locations and a thread data layout for each of the plurality of threads. The apparatus may also determine, prior to an alignment of the data or a refrainment from alignment of the data, whether the data for each of the plurality of threads is aligned with the allocated memory location in the plurality of memory locations. Further, the apparatus may align the data for each of the plurality of threads with the allocated memory location if the data is not aligned with the allocated memory location; or refrain from aligning the data for each of the plurality of threads with the allocated memory location if the data is aligned with the allocated memory location. The apparatus may also update, based on a rotated byte mask, each byte in a set of bytes within a data block for the data for each of the plurality of threads. The apparatus may also load or store, in an allocated memory location, the aligned data for each of the plurality of threads or the refrained from aligned data for each of the plurality of threads based on a request for the data for the allocated memory location. The apparatus may also output an indication of the aligned data for each of the plurality of threads or the refrained from aligned data for each of the plurality of threads.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example image or surface in accordance with one or more techniques of this disclosure.

FIG. 5 is a diagram illustrating an example geometry pipeline in accordance with one or more techniques of this disclosure.

FIG. 6 is a diagram illustrating an example GPU hardware in accordance with one or more techniques of this disclosure.

FIG. 7 is a diagram illustrating an example execution sequence in accordance with one or more techniques of this disclosure.

FIG. 8 is a diagram illustrating an example data layout process in accordance with one or more techniques of this disclosure.

FIG. 9 is a diagram illustrating an example data rotation process in accordance with one or more techniques of this disclosure.

FIG. 10 is a diagram illustrating an example data rotation process in accordance with one or more techniques of this disclosure.

FIG. 11 is a diagram illustrating an example data coalescing process in accordance with one or more techniques of this disclosure.

FIG. 12 is a diagram illustrating an example address comparison process in accordance with one or more techniques of this disclosure.

FIG. 13 is a diagram illustrating an example data alignment process in accordance with one or more techniques of this disclosure.

FIG. 14 is a diagram illustrating an example data alignment process in accordance with one or more techniques of this disclosure.

FIG. 15 is a diagram illustrating an example data alignment process in accordance with one or more techniques of this disclosure.

FIG. 16 is a communication flow diagram illustrating example communications between a GPU, a GPU/CPU, and a memory in accordance with one or more techniques of this disclosure.

FIG. 17 is a flowchart of an example method of graphics processing in accordance with one or more techniques of this disclosure.

FIG. 18 is a flowchart of an example method of graphics processing in accordance with one or more techniques of this disclosure.

### DETAILED DESCRIPTION

In some aspects, GPUs may group multiple threads in order to execute these threads at a same time or in lock-step. Additionally, when accessing memory, multiple threads may access the memory in a parallel fashion. Threads may also operate on a variable data size in any memory location. For example, 16 threads may work in parallel with the building blocks in a GPU. A typical GPU may have a number of building blocks (e.g., tens or hundreds of building blocks). In some instances, each thread may access 1 byte (1 B) to 16 bytes (16 B) of data in any memory location, depending on a real use case. Further, GPUs may need a large amount of logic in order to map data between the massive amount of threads and memory. Accordingly, this may introduce a large challenge for GPUs in terms of performance, timing, area, and/or power. GPUs may run with a large amount of parallel threads in order to achieve a high computing throughput. Each thread at a GPU may have its own program counter (PC), independent memory address, and/or access a small memory location. To achieve a high efficiency, a GPU may need to coalesce threads as much as possible in order to access memory in larger chunks. Moreover, each thread may request an arbitrary size/address of memory location. When an increasing number of compute shaders are run on a GPU, the efficiency of memory access for parallel threads is important for GPU performance and power utilization. Based on this, GPUs may need a large amount of logic in order to map data between the large amount of threads and memory. Indeed, different types of logic designs may result in a big difference regarding performance, timing, area, and power. That is, as GPUs are becoming increasingly complex, an increased amount of threads may be utilized and these threads may need to work in parallel and in order to operate correctly. And multiple threads may need to be able to access memory in parallel (i.e., at the same time). There is an issue when a large amount of these are working in parallel and accessing similar memory locations. Based on the above, it may be beneficial for a GPU to utilize a large amount of threads in parallel. Aspects presented herein may allow GPUs to utilize a large amount of threads in parallel (i.e., at the same time).

Aspects of the present disclosure may include a number of benefits or advantages. For instance, aspects of the present disclosure may allow GPUs to utilize a large amount of threads in parallel (i.e., at the same time). Aspects presented herein may also provide GPUs with the ability to allow threads to access memory in parallel (i.e., at the same time). Further, aspects presented herein may provide an efficient logic structure within a GPU in order to allow these threads to access memory in parallel (i.e., at the same time). For instance, aspects presented herein may provide an efficient logic structure within a GPU to be able to map these threads-to-memory conversions and to increase storage capabilities. That is, aspects presented herein may efficiently map a number of threads to a memory location or a data access location within the memory location. In order to do so, aspects presented herein may allocate a memory location at a GPU for data for multiple threads. Aspects presented herein may align the data for each of the threads with the allocated memory location if the data is not aligned with the allocated memory location. Also, aspects presented herein may refrain from aligning the data for each of the threads with the allocated memory location if the data is aligned with the allocated memory location. By doing so, aspects presented herein may optimize the performance, timing, area, and power utilized at a GPU. For example, aspects presented herein may increase GPU performance, improve GPU timing, reduce the amount of GPU area utilized, and/or reduce the amount of power utilized at the GPU.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended. In some examples, as used herein, the term “graphics workload” may refer to any workload or order associated with graphics processing. In some examples, as used herein, the term “texture fetch” may refer to a memory request, which incurs transactions from a cache (e.g., a texture cache). Each time a warp executes a texture function to read from texture memory, this may be a single texture fetch. Also, texture memory may be read-only device memory, and may be accessed using the device functions described in a texture function. Reading a texture using one of these functions may be called a “texture fetch.” A “render target” may refer to a target block of pixels (buffer) into which rendering will occur. In some aspects, a render target may refer to a buffer where the pixels are drawn (e.g., a video card draws pixels) for a scene that is being rendered in the background. An intermediate render target may refer to a render target that is used in post-processing.

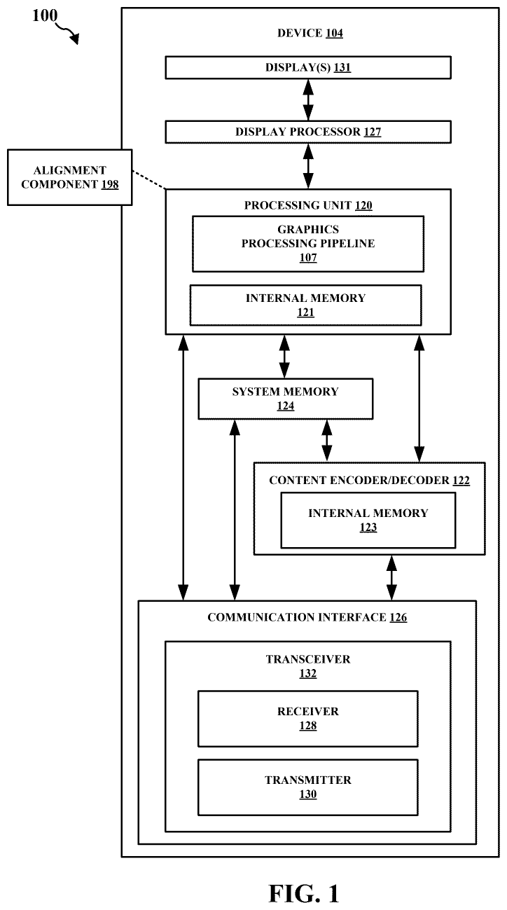

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an alignment component 198 configured to output a request for data for each of a plurality of threads associated with graphics processing, where an allocation of a memory location for the data for each of the plurality of threads is based on the request. The alignment component 198 may also be configured to obtain, based on the request, an indication of the data for each of the plurality of threads, where each of the plurality of threads includes corresponding data. The alignment component 198 may also be configured to adjust a data size for the data for each of the plurality of threads to a uniform data size, and where allocating a memory location in a plurality of memory locations for the data for each of the plurality of threads comprises: allocating, based on the uniform data size, the memory location in the plurality of memory locations for the data for each of the plurality of threads. The alignment component 198 may also be configured to identify an address for each of a plurality of cache banks; and determine whether an address for each cache line for at least one first thread in the plurality of threads is equivalent to an address for each cache line for at least one second thread for each of the plurality of cache banks. The alignment component 198 may also be configured to coalesce the data for the at least one first thread and the at least one second thread into a same cache line if the address for each cache line for the at least one first thread is equivalent to the address for each cache line for the at least one second thread for each of the plurality of cache banks. The alignment component 198 may also be configured to allocate a memory location in a plurality of memory locations for data for each of a plurality of threads. The alignment component 198 may also be configured to multiplex the data for each of the plurality of threads between a memory data layout for the plurality of memory locations and a thread data layout for each of the plurality of threads. The alignment component 198 may also be configured to determine, prior to an alignment of the data or a refrainment from alignment of the data, whether the data for each of the plurality of threads is aligned with the allocated memory location in the plurality of memory locations. The alignment component 198 may also be configured to align the data for each of the plurality of threads with the allocated memory location if the data is not aligned with the allocated memory location; or refrain from aligning the data for each of the plurality of threads with the allocated memory location if the data is aligned with the allocated memory location. The alignment component 198 may also be configured to update, based on a rotated byte mask, each byte in a set of bytes within a data block for the data for each of the plurality of threads. The alignment component 198 may also be configured to load or store, in an allocated memory location, the aligned data for each of the plurality of threads or the refrained from aligned data for each of the plurality of threads based on a request for the data for the allocated memory location. The alignment component 198 may also be configured to output an indication of the aligned data for each of the plurality of threads or the refrained from aligned data for each of the plurality of threads. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

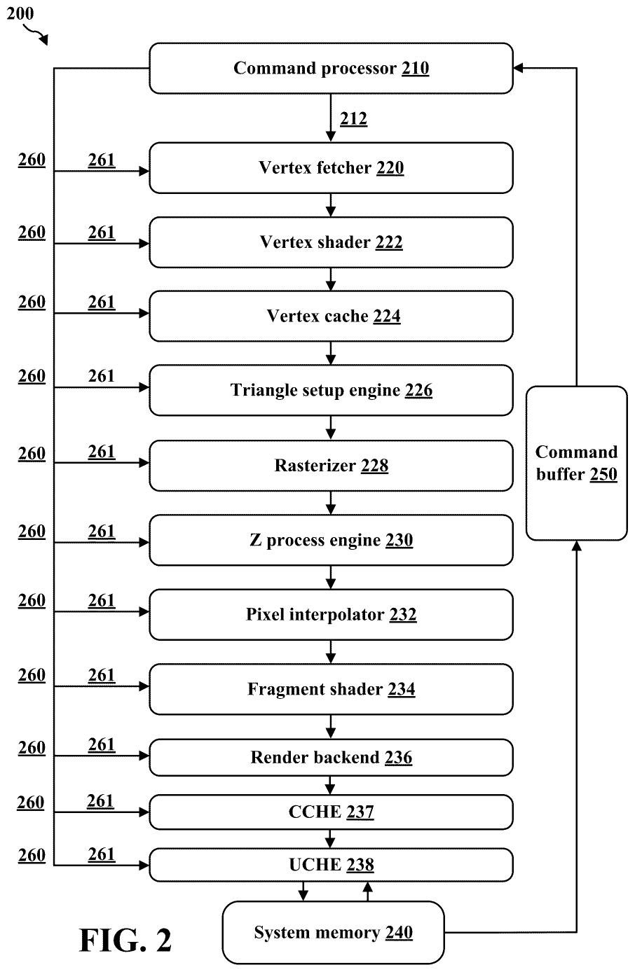

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in double data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

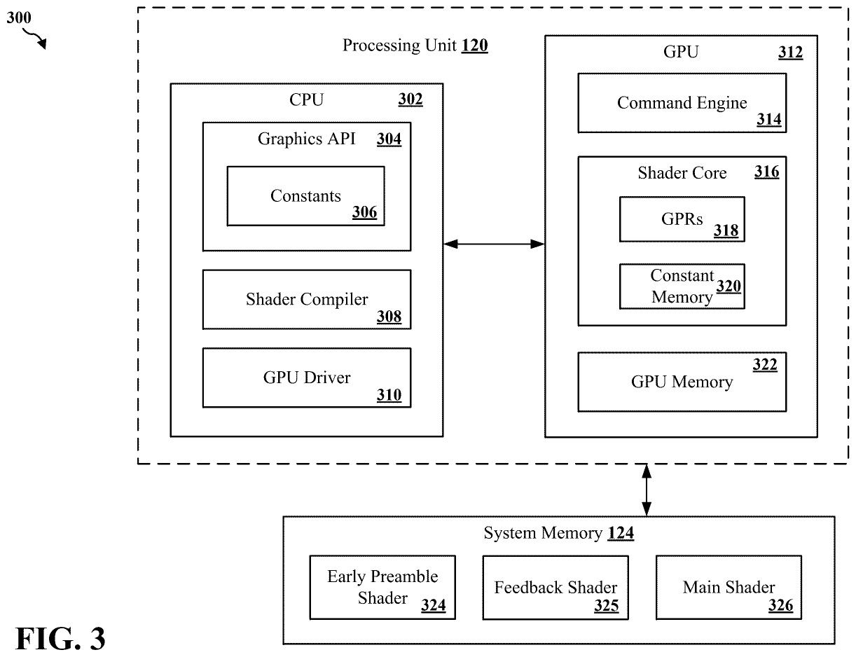

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

GPUs can render images in a variety of different ways. In some instances, GPUs can render an image using rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects, during the binning pass, a visibility stream can be constructed where visible primitives or draw calls can be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering.

In some aspects, GPUs can apply the drawing or rendering process to different bins or tiles. For instance, a GPU can render to one bin, and perform all the draws for the primitives or pixels in the bin. During the process of rendering to a bin, the render targets can be located in the GMEM. In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory used to drop primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

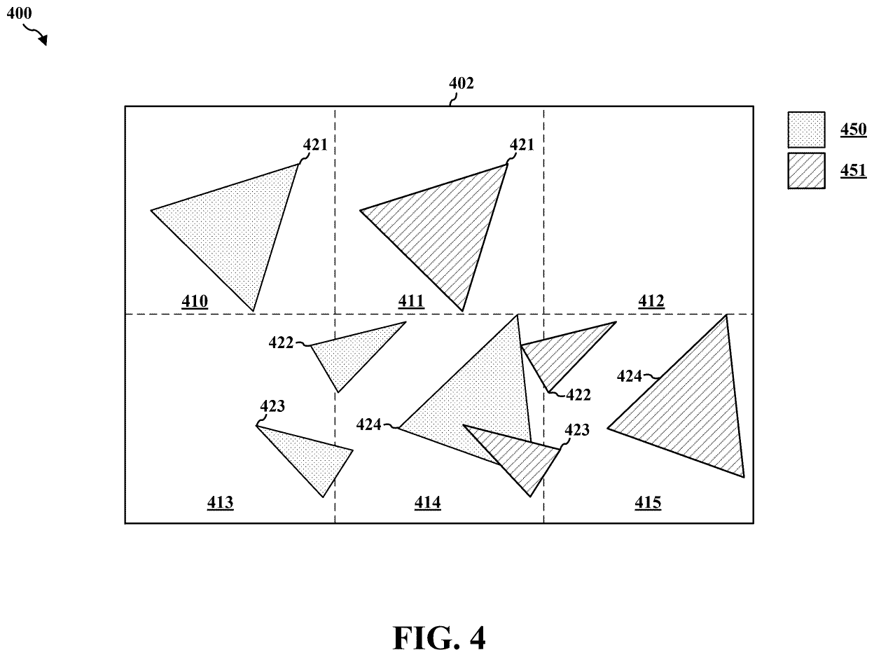

FIG. 4 illustrates image or surface 400, including multiple primitives divided into multiple bins. As shown in FIG. 4, image or surface 400 includes area 402, which includes primitives 421, 422, 423, and 424. The primitives 421, 422, 423, and 424 are divided or placed into different bins, e.g., bins 410, 411, 412, 413, 414, and 415. FIG. 4 illustrates an example of tiled rendering using multiple viewpoints for the primitives 421-424. For instance, primitives 421-424 are in first viewpoint 450 and second viewpoint 451. As such, the GPU processing or rendering the image or surface 400 including area 402 can utilize multiple viewpoints or multi-view rendering.

As indicated herein, GPUs or graphics processor units can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

In some aspects of graphics processing, GPU hardware may be divided into multiple sections, e.g., hardware for geometry processing and hardware for pixel processing. Scalable GPU hardware may be desirable in order to meet different throughputs across various market segments. Also, in some aspects, scalable hardware for pixel processing may be designed in a variety of ways. For instance, a screen may be divided into different parts and multiple pixel processing hardware modules (i.e., slices) may work independently on different parts of the screen. By changing the number of pixel slices, a scalable throughput may be achieved for different tiers. However, designing scalable geometry processing hardware has an inherent challenge of evenly distributing the workload across independently working hardware modules (i.e., geometry slices).

There are a number of issues that may be encountered when designing scalable geometry processing hardware. For instance, the variable size of a drawcall (i.e., a work unit) and an adaptive workload expansion in the middle of the geometry pipeline are some issues that may occur when designing scalable geometry processing hardware. Workloads across different draw calls may vary, so tying each drawcall to a geometry slice may create uneven data downstream. Apart from this, an application program interface (API) may specify that a geometry pipeline may support adaptive workload expansion/reduction through different features, e.g., tessellation, geometry shading, and/or triangle culling.

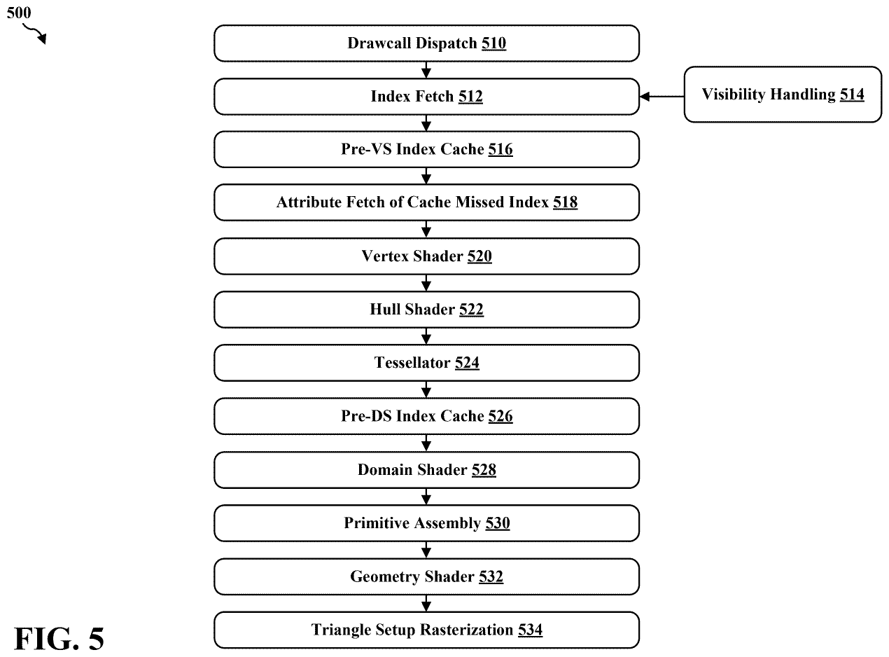

FIG. 5 is a diagram 500 illustrating an example geometry pipeline in a GPU. As depicted in FIG. 5, diagram 500 includes a drawcall dispatch 510, an index fetch 512, a visibility handling step 514, a pre-vertex shader index cache 516, an attribute fetch of a cache missed index 518, a vertex shader 520, a hull shader 522, a tessellator 524, a pre-domain shader index cache 526, a domain shader 528, a primitive assembly 530, a geometry shader 532, and a triangle setup rasterization 534. As shown in FIG. 5, after an index fetch 512, each primitive may be expanded to create multiple primitives, where an amplification factor may be determined during run-time. As such, sending primitives to different modules without considering an amplification factor may create an unequal workload in a downstream pipeline. Accordingly, this may prevent the achievement of an optimal throughput.

Another issue that may be encountered when designing scalable geometry processing hardware is visibility handling (e.g., tiled rendering) across multiple geometry slices. As indicated above, in tile-based rendering, the screen is divided into multiple bins, and a binning pass is used to generate a per-bin visibility stream (i.e., primitives that may be identified as visible in a bin). Also, the visibility stream may be used in multiple bin-rendering passes (e.g., dropping invisible primitives from processing) to render the whole screen. Because of different visibilities of primitives, the workload pattern in each bin-rendering pass may vary significantly from a binning pass. A workload distribution scheme may need to ensure that an even workload (including amplification) is distributed to each geometry slice (even when accounting for the potential disparity in visibility).

In some aspects, different types of GPU hardware may support different types of workload execution. Additionally, different types of workloads may take a different amount of processing time in various stages of the GPU pipeline. Also, these types of workloads may introduce inefficiency in GPU hardware utilization. In some aspects, scheduling algorithms in order to time-share the GPU hardware may sequence the workload to achieve the best utilization of GPU hardware. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

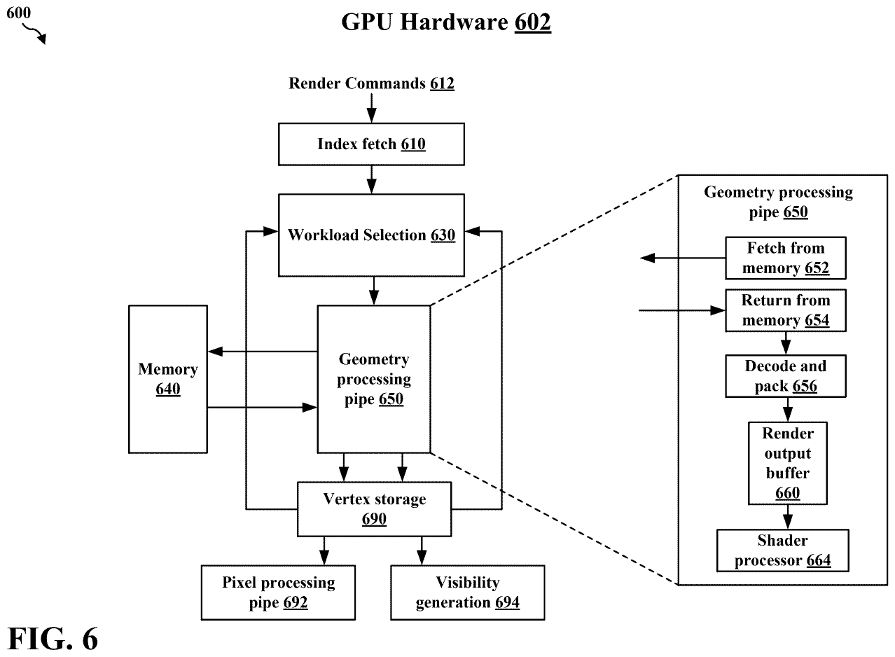

FIG. 6 illustrates diagram 600 including one example of GPU hardware. More specifically, diagram 600 depicts a time-shared GPU hardware for concurrent binning. As shown in FIG. 6, diagram 600 includes GPU hardware 602 including index fetch component 610, workload selection component 630, memory 640, geometry processing pipe 650, vertex storage component 690, pixel processing pipe 692, and visibility generation component 694. As shown in FIG. 6, render commands 612 may be input to index fetch component 610, which may be output to workload selection component 630. The workload selection component 630 may have a render/sort selection capability, as well as a certain granularity (e.g., a granularity for a group of N primitives). Also, the workload selection component 630 may be referred to as a workload selection switch component, switch component, workload selection component, or selection component. The “switch” may refers to a switch in the selection of render/sorting workloads. The output of workload selection component 630 may be sent to geometry processing pipe 650, which may communicate with memory 640. The geometry processing pipe 650 may include fetch from memory component 652, return from memory component 654, decode and pack component 656, render output buffer 660, and shader processor 664. Also, the output of geometry processing pipe 650 may be sent to vertex storage component 690, which may be sent to pixel processing pipe 692 and visibility generation component 694.

As shown in FIG. 6, geometry pipe hardware (e.g., geometry processing pipe 650) may be time shared between tile sorting and tile render workloads. Also, a scheduling algorithm (e.g., workload selection component 630) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 6, the workload selection component 630 may have a granularity of a group of N primitives. For instance, for concurrent binning, the workload distribution granularity may be a primitive batch (e.g., a set of N primitives).

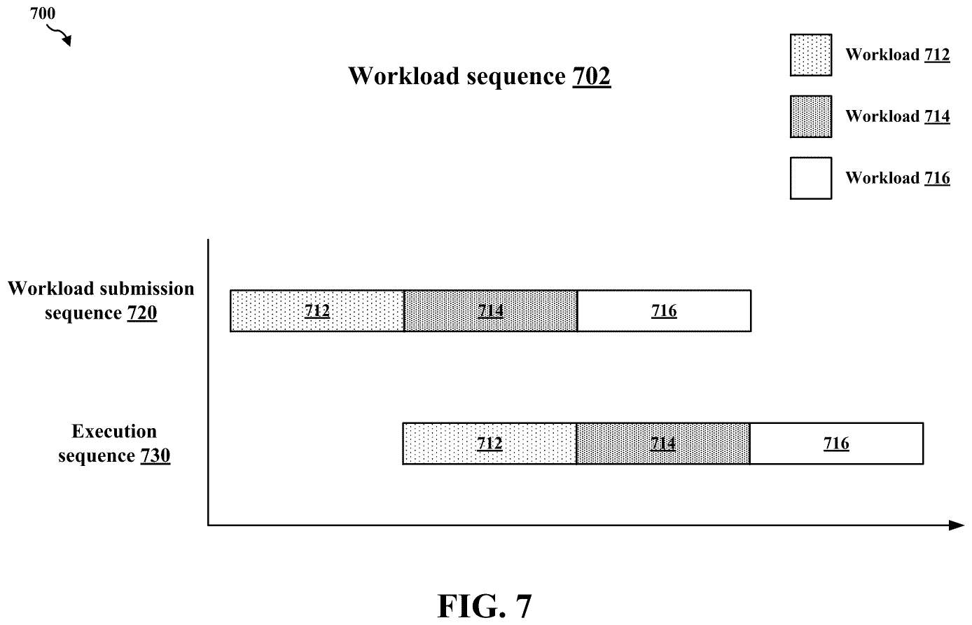

Certain types of workloads (e.g., sorting workloads) may face higher memory access latencies compared to other types of workloads (e.g., render workloads). For example, render workloads may be of higher priority than sorting workloads, which may face higher memory access latencies. In some aspects, if these types of workloads (e.g., sorting workloads) are executed in-order as per the scheduled workload sequence and granularity, there may be a reduction in hardware efficiency. For instance, if these types of workloads (e.g., sorting workloads) are executed in-order as per the scheduled workload sequence and granularity, a certain workload block (e.g., a head-of-line block) may occur, thus reducing the hardware efficiency. This type of scenario is shown in FIG. 7.

FIG. 7 illustrates diagram 700 including one example of a workload execution sequence. More specifically, diagram 700 depicts a workload execution sequence for a GPU (i.e., a scheduled execution order). As shown in FIG. 7, diagram 700 includes workload sequence 702 including workload 712, workload 714, workload 716, workload submission sequence 720, and execution sequence 730. FIG. 7 depicts a timeline of workload execution including workload submission sequence 720 and execution sequence 730. FIG. 7 illustrates that certain types of workloads (e.g., workload 712, workload 714, and workload 716) are executed in a certain order as per the scheduled workload sequence. As shown in FIG. 7, consider a workload submission sequence 720 (e.g., as determined by the workload selection component 630 in FIG. 6) to be workload 712, workload 714, and workload 716. Each of these workload may need to fetch data from memory (e.g., memory 640) and send it to shader processor (e.g., shader processor 664) for further processing. In some aspects, there may be a limit on how many requests can be made without processing the returned data (e.g., an OT limit). In some instances, some of the memory accesses for workload 714 may be granted before all accesses for workload 712, and some of the memory accesses for workload 716 may be granted before all accesses for workload 714.

In some aspects of graphics rendering, some graphics applications may render to a single target, i.e., a render target, one or more times. For instance, in graphics rendering, a frame buffer on a system memory may be updated multiple times. The frame buffer may be a portion of memory or random access memory (RAM) (e.g., containing a bitmap or storage) to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

As indicated herein, graphics processors (e.g., GPUs) may work in a number of different fashions (e.g., a single instruction, multiple data (SIMD) fashion). GPUs may process certain types of instructions that are associated with an operation (e.g., an SIMD operation). For instance, a GPU may process wave instructions or waves, which are the width of data elements that are operated on by a single instruction associated with the SIMD. The term wave may also refer to a set of threads or blocks that run concurrently on the GPU. Waves may be allocated into sub-waves, which may include a number of threads or fibers. An active thread/fiber may refer to a thread/fiber that executes instructions (e.g., instructions in the ALU). An inactive thread/fiber may refer to a thread/fiber that does not execute instructions. Threads/fibers that do not partake in a branching operation may eventually become inactive (i.e., partake in the next level of the hierarchy). A kernel may be a programming operations manager or a programming thread at a GPU. Also, a kernel may be executed in parallel by an array of threads/fibers, where all threads/fibers may run the same code. Each thread/fiber may have an identifier (ID) that it uses to compute memory addresses and make control decisions. GPUs may also process a number of different operations, such as an atomic operation. An atomic operation may enable another operation (e.g., a read-modify-write operation or a read-write operation) to occur without any interruption. As such, an atomic operation may assure that no other execution operation at a GPU may have been inserted between the target operation (e.g., a read-modify-write operation or a read-write operation).

In some aspects, a shader in the context of a graphics processor (e.g., a GPU) may be a program that is used to control the rendering effects of 3D computer graphics. There are different types of shaders (e.g., vertex shaders, pixel shaders, and geometry shaders), each of which may handle a different aspect of the rendering process. Shaders may be used to produce realistic lighting, shadows, textures, and other visual effects in video games, simulations, and other 3D applications. A shader processor may utilize one or more context states to perform various operations and calculations. For instance, a shader processor may be part of multiple shared cores for integer processing. Also, a shader processor may execute shader code (e.g., vertex shaders, fragment shaders, compute shaders, etc.). The shader processor may also be referred to as a shader core. Shader code may also be referred to as a shader and may refer to a user-defined program configured to run in a stage of the GPU. In an example, the shader code may be associated with the rendering of graphical content. The shader processor may include a number of different components, such as arithmetic logic units (ALUs) and general purpose registers (GPRs). An ALU may be a combinatorial digital circuit that performs arithmetic and bitwise operations on integer binary numbers (e.g., a signed integer, an unsigned integer, etc.). A GPR may be a register that stores both data and addresses, that is, the GPR may be a combined data/address register. A register may refer to a location that may be accessed by a processor. A register may include a small amount of relatively quickly accessible storage.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock.

A symmetric multiprocessor (SM) may be single instruction multiple thread processor which has multiple shared cores at a GPU (e.g., shader processors) for integer processing, special functional units (SFUs) (e.g., for calculating functions such as sine, cosine, root mean-squared (RMS), etc.). The SM may have load store (LD/ST) units for load and store into memory/registers. The SM may also have L1 caches, shared caches and large-banked register files. A concurrent thread array (CTA) may be a basic workload unit assigned to an SM in a GPU. Threads in a CTA may be sub-grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization/pointer of coherence (PoS/PoC) may be point in the system-on-chip (SoC) post where every master in the system may see the same coherent copy of data.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

In some aspects, GPUs may group multiple threads in order to execute these threads at a same time or in lock-step. Additionally, when accessing memory, multiple threads may access the memory in a parallel fashion. Threads may also operate on a variable data size in any memory location. For example, 16 threads may work in parallel with the building blocks in a GPU. A typical GPU may have a number of building blocks (e.g., tens or hundreds of building blocks). In some instances, each thread may access 1 byte (1 B) to 16 bytes (16 B) of data in any memory location, depending on a real use case. Further, GPUs may need a large amount of logic in order to map data between the massive amount of threads and memory. Accordingly, this may introduce a large challenge for GPUs in terms of performance, timing, area, and/or power.

As indicated herein, GPUs may run with a large amount of parallel threads in order to achieve a high computing throughput. Each thread at a GPU may have its own program counter (PC), independent memory address, and/or access a small memory location. To achieve a high efficiency, a GPU may need to coalesce threads as much as possible in order to access memory in larger chunks. Moreover, each thread may request an arbitrary size/address of memory location. When an increasing number of compute shaders are run on a GPU, the efficiency of memory access for parallel threads is important for GPU performance and power utilization. Based on this, GPUs may need a large amount of logic in order to map data between the large amount of threads and memory. Indeed, different types of logic designs may result in a big difference regarding performance, timing, area, and power. That is, as GPUs are becoming increasingly complex, an increased amount of threads may be utilized and these threads may need to work in parallel and in order to operate correctly. And multiple threads may need to be able to access memory in parallel (i.e., at the same time). There is an issue when a large amount of these are working in parallel and accessing similar memory locations. Based on the above, it may be beneficial for a GPU to utilize a large amount of threads in parallel (i.e., at the same time). It may also be beneficial for a GPU to allow these threads to access memory in parallel (i.e., at the same time). In turn, it may be beneficial to provide an efficient logic structure within a GPU in order to allow these threads to access memory in parallel (i.e., at the same time). For instance, it may be beneficial to provide an efficient logic structure within a GPU to be able to map these threads-to-memory conversions and to increase storage capabilities.

Aspects of the present disclosure may allow GPUs to utilize a large amount of threads in parallel (i.e., at the same time). Aspects presented herein may also provide GPUs with the ability to allow threads to access memory in parallel (i.e., at the same time). Further, aspects presented herein may provide an efficient logic structure within a GPU in order to allow these threads to access memory in parallel (i.e., at the same time). For instance, aspects presented herein may provide an efficient logic structure within a GPU to be able to map these threads-to-memory conversions and to increase storage capabilities. That is, aspects presented herein may efficiently map a number of threads to a memory location or a data access location within the memory location. In order to do so, aspects presented herein may allocate a memory location at a GPU for data for multiple threads. Aspects presented herein may align the data for each of the threads with the allocated memory location if the data is not aligned with the allocated memory location. Also, aspects presented herein may refrain from aligning the data for each of the threads with the allocated memory location if the data is aligned with the allocated memory location. By doing so, aspects presented herein may optimize the performance, timing, area, and power utilized at a GPU. For example, aspects presented herein may increase GPU performance, improve GPU timing, reduce the amount of GPU area utilized, and/or reduce the amount of power utilized at the GPU.

In some aspects, there may be a large amount of threads that are working independently and in parallel, each of which may need to access a memory location at the same time. So there may be a limited number of data channels and to provide the correct bandwidth, GPUs may utilize a cache hierarchy, but each hierarchy may also be working on a value to access the memory. Aspects presented herein may optimize or adjust the granularity of storing and/or accessing the data for the threads in the memory location. For instance, since there is a large amount of threads and each thread may include a different granularity, when memory is accessed, aspects presented herein may need to utilize a different granularity to access the memory location. For example, aspects presented herein may utilize a large or smaller granularity to access the memory location. That is, aspects presented herein may utilize GPU logic to convert data from one thread to memory, as well as coalesce multiple threads into a group of threads in order to access the memory location. Additionally, aspects presented herein may efficiently map the data for each of the threads to the data access location in the memory. For instance, aspects presented herein may rotate or adjust the data for each of the threads in order to access the data in the memory location.

In some instances, aspects presented herein may adjust or unify the granularity of the data size for different threads in order to optimize the data size for each thread. For example, aspects presented herein may adjust or unify the granularity of the data size for different threads to be multiple blocks of data (e.g., 32 bit (32 b) blocks or 4 byte (4 B) blocks). That is, aspects herein may unify different conditions from a thread point of view in order to unify conform to a single granularity. Aspects presented herein may also map the data between the threads and the memory location. For instance, aspects presented herein may map the data between the threads and the memory location based on a certain granularity (e.g., a 32 b or 4 B granularity). In order to do so, aspects presented herein may allocate a certain memory location for data for the threads, and then align the data for the threads with the allocated memory location. Also, aspects presented herein may multiplex the data for each of the threads (e.g., multiplex 32 b or 4 B data from each of the threads). Further, aspects presented herein may rotate the data within a certain block to the corresponding memory location (e.g., rotate the data within a 32 b or 4 B block to a memory location). In some instances, when one thread block maps to multiple memory blocks (e.g., two memory blocks), aspects herein may process the data twice, and operate a portion of the memory block each time. Moreover, when parallel threads access memory through a cache, aspects herein may coalesce the data for multiple cache line simultaneously to increase throughput. In some aspects, when parallel threads have a same address, aspects herein may broadcast the data for a read, in-order access for a write process, as well as broadcast the data sequential access for atomic memory access. Aspects presented herein may also utilize a triangular comparison for a sequential atomic memory access.

Aspects presented herein may utilize an efficient and well-organized design for GPU architecture (ARCH) or microarchitecture (uARCH) to achieve a high GPU efficiency. In order to do so, aspects herein may define a number of blocks (e.g., a number of 4 byte (4 B) blocks) as a basic granularity to covert a data layout between the threads and the memory. Aspects presented herein may also rotate or adjust data within a data block (e.g., a 32 b or 4 B data block) to a corresponding memory location. In some instances, aspects presented herein may utilize a write enable to update a data block (e.g., one block) for one cycle if the data crosses into multiple blocks (e.g., two blocks). Further, aspects herein may utilize a data comparison in order to prevent accessing a same address in the memory location. For example, aspects herein may utilize a triangular comparison in order to prevent accessing a same address in the memory location for atomic memory access. In some aspects, when parallel threads access memory through a cache, aspects herein may coalesce the data for multiple cache lines (e.g., coalesce the data in parallel) in order to increase the throughput.

In some instances, aspects herein may multiplex the data for threads between a memory data layout and a thread data layout. For instance, aspects herein may multiplex, based on a data granularity or a block granularity, the data for each of the threads between a memory data layout for the memory locations and a thread data layout for the plurality of threads. In a thread data layout, the threads may operate on different data sizes (e.g., 1 B to 16 B) depending on the use case. Also, in a thread data layout, the threads may start from any memory address, and there may be no condition regarding data alignment. For a thread data layout, aspects herein may define a certain data size (e.g., a 32 b or 4 B data size) as a thread block for each thread. Also, aspects herein may map the thread data to any address in the memory. Further, one thread may occupy a certain block footprint (e.g., a 1 to 4 block footprint) depending on its data size. For a memory data layout, aspects herein may define a certain data size (e.g., a 32 b or 4 B data size) as a memory block. The memory data layout may be aligned for a certain data size (e.g., aligned for a 32 b or 4 B data size).

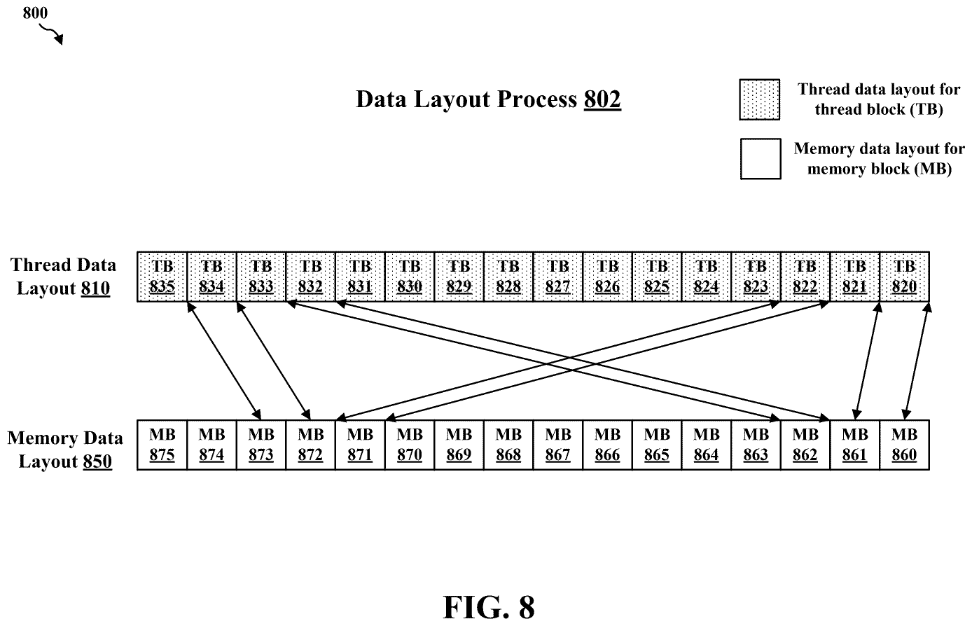

FIG. 8 illustrates diagram 800 including one example of a data layout process. More specifically, diagram 800 depicts an example of data layout process 802 that multiplexes data for threads between a thread data layout and a memory data layout. As shown in FIG. 8, diagram 800 includes thread data layout 810 including a number of thread blocks (TBs) (e.g., TB 820, TB 821, TB 822, TB 823, TB 824, TB 825, TB 826, TB 827, TB 828, TB 829, TB 830, TB 831, TB 832, TB 833, TB 834, and TB 835) and memory data layout 850 including a number of memory blocks (MBs) (e.g., MB 860, MB 861, MB 862, MB 863, MB 864, MB 865, MB 866, MB 867 MB 868, MB 869, MB 870, MB 871, MB 872, MB 873, MB 874, and MB 875). The thread data layout 810 for TBs is shown as dotted blocks and the memory data layout 850 for MBs is shown as white blocks. As shown in FIG. 8, for thread data layout 810, the threads may start from any memory address, and there may be no condition regarding data alignment. For thread data layout 810, a certain data size (e.g., a 32 b or 4 B data size) may be defined as a TB for each thread. Further, one thread may occupy a certain block footprint (e.g., a 1 to 4 block footprint) depending on its data size. For memory data layout 850, a certain data size (e.g., a 32 b or 4 B data size) may be defined as a memory block. The memory data layout 850 may also be aligned for a certain data size (e.g., aligned for a 32 b or 4 B data size).

As shown in FIG. 8, the data for threads may be multiplexed between thread data layout 810 and memory data layout 850. For instance, based on a data granularity or a block granularity, the data for each of the threads may be multiplexed between thread data layout 810 for the threads and memory data layout 850 for the memory locations. In some instances, the thread data for thread data layout 810 may be mapped to any address in the memory for memory data layout 850. As shown in FIG. 8, each block may be 4 B data and there may be two lines for each block in FIG. 8 to indicate the start and end of the block. For example, as shown in FIG. 8, TB 834 may not be 4 B aligned, as it may map to part of MB 872 and part of MB 873. TB 832 may be 4 B aligned, as it may map to MB 862. Also, TB 822 may be 4 B aligned, as it may map to MB 871. Further, TB 820 may not be 4 B aligned, as it may map to part of MB 860 and part of MB 861. Also, for the mapping, the data for certain TBs in thread data layout 810 may start from a certain memory address in memory data layout 850. For example, the data for TB 820 may start from memory address 0x3, the data for TB 822 may start from memory address 0x2c, the data for TB 832 may start from memory address 0x8, and the data for TB 834 may start from memory address 0x32.

In some instances, aspects presented herein may rotate data within a block for data layout conversion. For instance, GPUs may rotate data within a memory block for data layout conversion. In order to do so, aspects presented herein may utilize a load process and/or a store process. For the load process, aspects herein may rotate data within a memory block according to a starting offset of a thread block. For instance, aspects herein may rotate byte data in a right direction within a memory block according to a starting offset of a thread block for a thread data layout. For the store process, aspects herein may rotate data within a thread block according to a starting offset. For instance, aspects herein may rotate byte data in a left direction within a thread block according to a starting offset for a memory data layout.

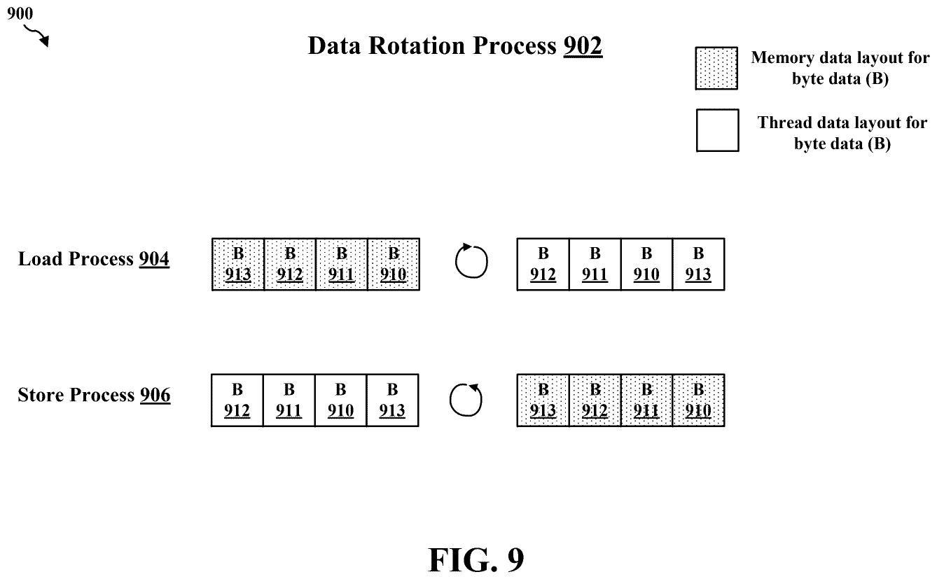

FIG. 9 illustrates diagram 900 including one example of a data rotation process. More specifically, diagram 900 depicts data rotation process 902 including load process 904 and store process 906. As shown in FIG. 9, diagram 900 includes load process 904 including different byte data (B) (e.g., byte data 910, byte data 911, byte data 912, and byte data 913) and store process 906 including different byte data (B) (e.g., byte data 910, byte data 911, byte data 912, and byte data 913). The memory data layout for byte data (B) is shown as dotted blocks and the thread data layout for byte data (B) is shown as white blocks. FIG. 9 depicts one example of a thread block that starts from a certain memory address (e.g., an address of 0x3). As shown in FIG. 9, for load process 904, the data within a memory block may be rotated according to a starting offset of a thread block. For instance, byte data (e.g., byte data 910, byte data 911, byte data 912, and byte data 913) may be rotated in a right direction within a memory block according to a starting offset of a thread block for a thread data layout. For example, the memory data layout may be 4 B aligned, and the thread data layout may be any offset, and may need to be rotated when loading data from memory or storing data to memory. For the store process 906, the data may be rotated within a thread block according to a starting offset. For instance, byte data (e.g., byte data 910, byte data 911, byte data 912, and byte data 913) may be rotated in a left direction within a thread block according to a starting offset for a memory data layout.

In some instances, aspects presented herein may utilize multiple transactions to process a thread block when mapping data to multiple memory blocks. For instance, aspects presented herein may utilize two transactions to process one thread block when data for the thread is mapped to multiple memory blocks (e.g., two memory blocks). Aspects presented herein may operate on a portion of the block for each of the multiple transactions. In order to do so, aspects presented herein may utilize a load process with multiple transactions and a store process with multiple transactions. For the load process, aspects presented herein may fetch data from multiple memory blocks (e.g., 2 memory blocks) in multiple transactions (e.g., 2 transactions). To do so, each transaction may obtain part of the thread block data. For the store process, aspects presented herein may store the data to multiple memory blocks (e.g., 2 memory blocks) in multiple transactions (e.g., 2 transactions). In order to do so, each transaction may update part of the memory block.

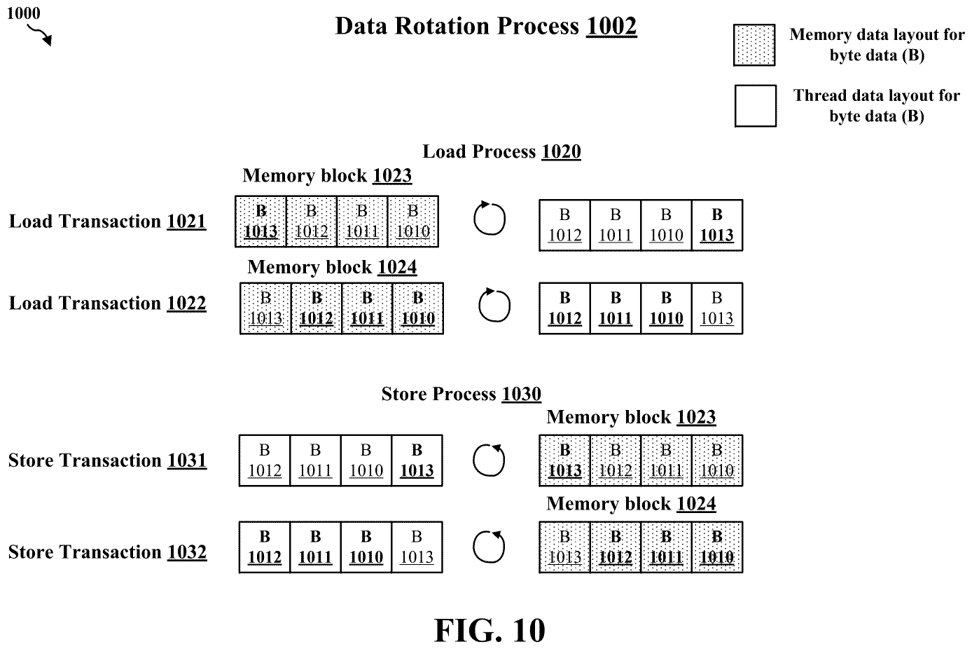

FIG. 10 illustrates diagram 1000 including one example of a data rotation process. More specifically, diagram 1000 depicts data rotation process 1002 including load process 1020 and store process 1030. As shown in FIG. 10, diagram 1000 includes load process 1020 including different byte data (B) (e.g., byte data 1010, byte data 1011, byte data 1012, and byte data 1013) and store process 1030 including different byte data (B) (e.g., byte data 1010, byte data 1011, byte data 1012, and byte data 1013). The load process 1020 includes multiple transactions (e.g., load transaction 1021 and load transaction 1022). The store process 1030 includes multiple transactions (e.g., store transaction 1031 and store transaction 1032). The memory data layout for byte data (B) is shown as dotted blocks and the thread data layout for byte data (B) is shown as white blocks. FIG. 10 depicts one example of a thread block that starts from a certain memory address (e.g., an address of 0x3). For example, the memory data layout may be 4 B aligned, and the thread data layout may be any offset, and may need to be rotated when loading data from memory or storing data to memory.

As shown in FIG. 10, for load process 1020, the data within a memory block may be rotated according to a starting offset of a thread block. For instance, byte data (e.g., byte data 1010, byte data 1011, byte data 1012, and byte data 1013) may be rotated in a right direction within a memory block according to a starting offset of a thread block for a thread data layout. Also, for load process 1020, data from multiple memory blocks (e.g., memory block 1023 and memory block 1024) may be fetched in multiple transactions (e.g., load transaction 1021 and load transaction 1022). To do so, each transaction (e.g., load transaction 1021 and load transaction 1022) may obtain part of the thread block data. For the store process 1030, the data may be rotated within a thread block according to a starting offset. For instance, byte data (e.g., byte data 1010, byte data 1011, byte data 1012, and byte data 1013) may be rotated in a left direction within a thread block according to a starting offset for a memory data layout. Further, for store process 1030, the data may be stored in multiple memory blocks (e.g., memory block 1023 and memory block 1024) in multiple transactions (e.g., store transaction 1031 and store transaction 1032). In order to do so, each transaction (e.g., store transaction 1031 and store transaction 1032) may update part of the memory block.

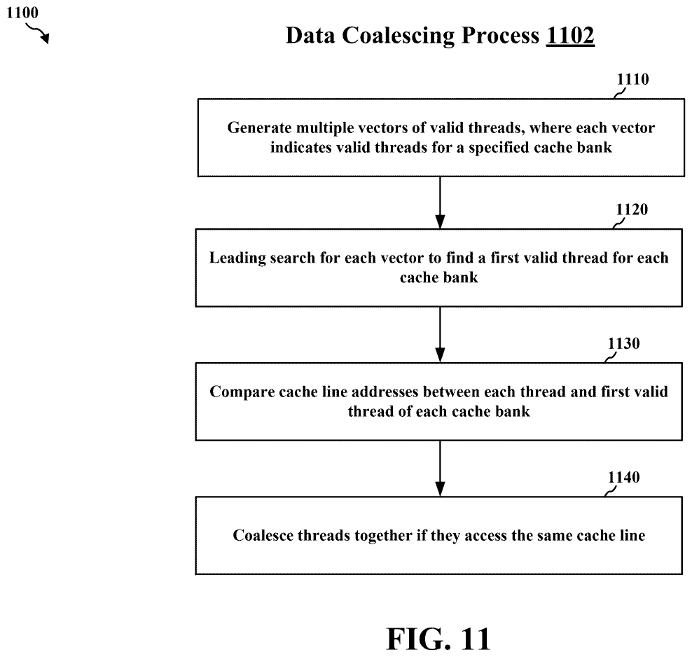

FIG. 11 illustrates diagram 1100 including one example of a data coalescing process. More specifically, diagram 1100 depicts data coalescing process 1102 that includes multiple steps to coalesce threads for multiple cache line in parallel to increase throughput. As shown in FIG. 11, at 1110, aspects presented herein may generate multiple vectors of valid threads. For example, a GPU may generate multiple vectors of valid threads (e.g., a PER_CACHE_BANK_VECTOR). Each vector may indicate a number of valid threads for a specified cache bank. At 1120, aspects presented herein may perform a leading search for each vector to find a first valid thread for each cache bank. For example, a GPU may perform a leading search (e.g., LeadingOne) for each vector to find a first valid thread for each cache bank. At 1130, aspects presented herein may compare cache line address between each thread and first valid thread of each cache bank. For example, a GPU may compare cache line address between each thread and first valid thread of each cache bank (e.g., CACHE_LINE_COMPARE). At 1140, aspects presented herein may coalesce the threads together if they access same cache line. For example, a GPU may coalesce the threads together if they access same cache line (e.g., Coalesced_Threads).

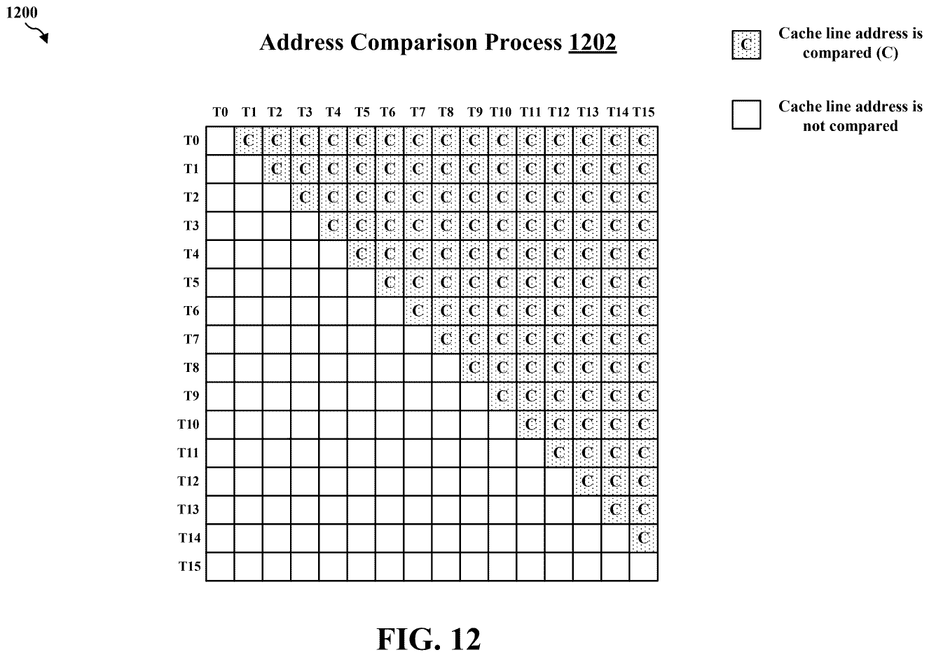

FIG. 12 illustrates diagram 1200 including one example of an address comparison process. More specifically, diagram 1200 depicts an address comparison process 1202 that includes a triangular comparison to prevent a same address for certain data. As shown in FIG. 12, address comparison process 1202 includes a table that depicts a number of threads (T) (e.g., thread 0 (T0) to thread 15 (T15)). The dotted boxes with a “C” depict that the cache line address for that thread is compared. The white boxes without a “C” depict that the cache line address for that thread is not compared. As shown in FIG. 12, aspects presented herein may compare an address within a cache line for each thread with all threads younger than the thread. For example, the cache line address for thread 2 (T2) is compared with thread 1 (T1) and thread 0 (T0). However, the cache line address for thread 2 (T2) is not compared with any other thread. By comparing the cache line addresses for each thread, aspects presented herein may generate a triangle map. Also, a thread with atomic data may be coalesced into a cache line if its address comparison vector is a certain value (e.g., a value of 0) or a matched thread cannot be coalesced (e.g., the threads have different cache line addresses).

In some instances, aspects presented herein may utilize a data alignment process. For instance, aspects presented herein may utilize a data alignment process including a complete data processing flow. Aspects presented herein may allow GPUs to obtain a request for a thread of a certain data size (e.g., a 32 b or 4 B data size) as a memory block. The GPU may then convert a different thread data size to multiple blocks for each thread. Also, the GPU may process a number of memory blocks (e.g., 16 memory blocks) every cycle. The GPU may then coalesce a number of memory blocks (e.g., 16 memory blocks) based on thread block address. When the thread block crosses a certain data boundary (e.g., a 32 b boundary), the GPU may split the process into multiple transactions (e.g., two transactions) and process by multiple cycles (e.g., two cycles). For example, the first cycle may process a starting portion of all memory blocks (e.g., 16 blocks), and the second cycle may process an ending portion of all memory blocks (e.g., 16 blocks). The GPU may then multiplex the data between a thread data layout and a memory data layout. Next, the GPU may rotate a data/mask for each block, as well as update each byte within a block based on the byte mask.

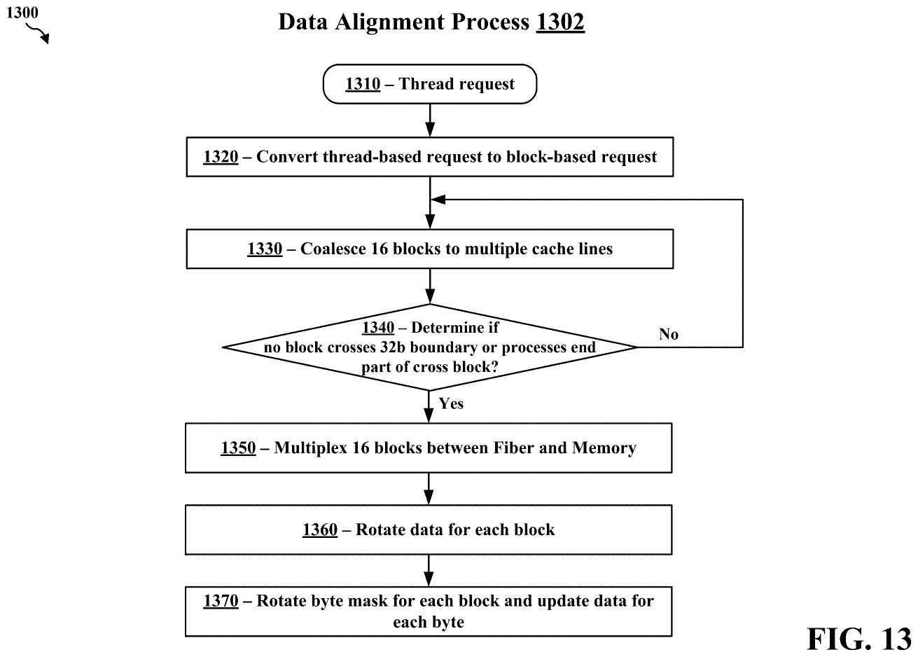

FIG. 13 illustrates diagram 1300 including one example of a data alignment process. More specifically, diagram 1300 depicts data alignment process 1302 including a complete data processing flow. At 1310, as shown in FIG. 13, a GPU may obtain a request for a thread of a certain data size (e.g., a 32 b or 4 B data size) as a memory block. At 1320, the GPU may convert a different thread data size (e.g., a thread-based request) to multiple blocks for each thread (e.g., a block-based request). The GPU may then process a number of memory blocks (e.g., 16 memory blocks) every cycle. At 1330, the GPU may coalesce a number of memory blocks (e.g., 16 memory blocks) based on thread block address to multiple cache lines. At 1340, the GPU may determine if no block crosses a certain boundary (e.g., a 32 b boundary) or processes an ending part of a cross block. For example, when the thread block crosses a certain data boundary (e.g., a 32 b boundary), the GPU may split the process into multiple transactions (e.g., two transactions) and process by multiple cycles (e.g., two cycles). The first cycle may process a starting portion of all memory blocks (e.g., 16 blocks), and the second cycle may process an ending portion of all memory blocks (e.g., 16 blocks). If the determination is no at 1340, the GPU may return to step 1330. If the determination is yes at 1340, the GPU may proceed to step 1350. At 1350, the GPU may multiplex the data for each memory block (e.g., 16 blocks), between a thread data layout (i.e., fiber) and a memory data layout (i.e., memory). At 1360, the GPU may rotate a data for each block. At 1370, the GPU may rotate a byte mask for each block and update data for each byte within a block based on the byte mask.

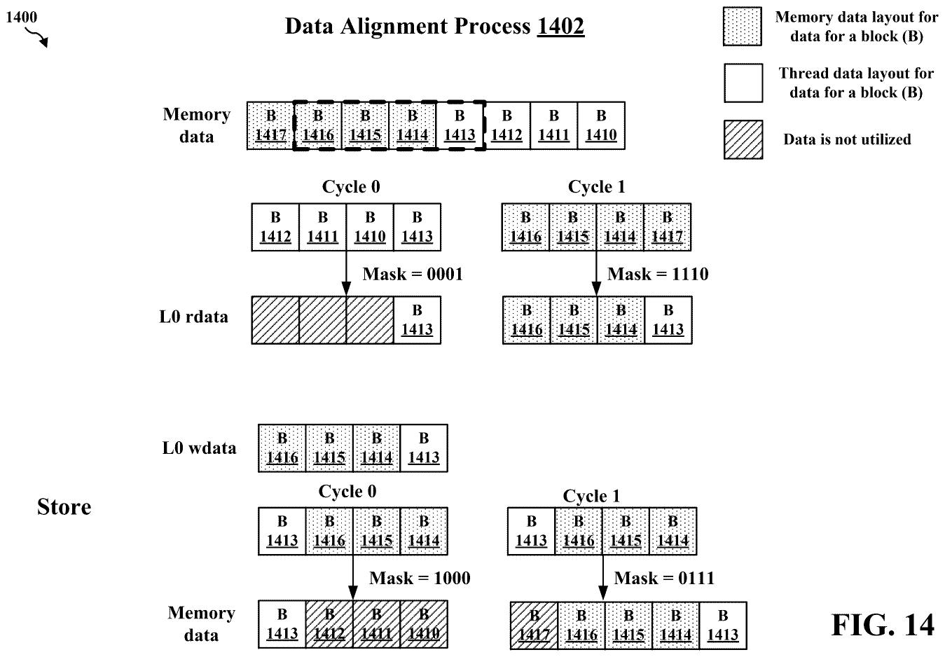

FIG. 14 illustrates diagram 1400 including one example of a data alignment process. More specifically, diagram 1400 depicts data alignment process 1402 that includes load process 1404 and store process 1406. As shown in FIG. 14, load process 1404 includes each byte (B) with a memory address offset (e.g., byte 1410, byte 1411, byte 1412, byte 1413, byte 1414, byte 1415, byte 1416, and byte 1417), a first cycle (cycle 0), a second cycle (cycle 1), a first mask (e.g., mask=0001), a second mask (e.g., mask =1110), and level 0 data (L0 rdata). For instance, load process 1404 shows how to rotate and merge each byte (B) during a load process. Also, store process 1406 includes each byte (B) with a memory address offset (e.g., byte 1410, byte 1411, byte 1412, byte 1413, byte 1414, byte 1415, byte 1416, and byte 1417), level 0 data (L0 wdata), a first cycle (cycle 0), a second cycle (cycle 1), a third mask (e.g., mask=1000), and a fourth mask (e.g., mask=0111). For instance, store process 1406 shows how to rotate and merge each byte (B) during a store process. The dotted blocks may represent a memory data layout for each byte (B) with a memory address offset, the white blocks may represent a thread data layout for each byte (B) with a memory address offset, and the diagonal blocks may represent that data is not utilized. As shown in FIG. 14, data alignment process 1402 includes an example of data/mask processing including a certain thread data size (e.g., a data size of 4 B or 32 b) and a certain thread address (e.g., 0x3). The GPU may cross block, and process in multiple cycles (e.g., two cycles). At cycle 0, the GPU may process a starting portion of the data. At cycle 1, the GPU may process an ending portion of the data.

As shown in FIG. 14, load process 1404 may utilize memory data for certain bytes (B) with a memory address offset (e.g., byte 1413, byte 1414, byte 1415, and byte 1416). Load process 1404 may load a data block for byte 1410, byte 1411, byte 1412, and byte 1413 for cycle 0, as well as load a data block for byte 1414, byte 1415, byte 1416, and byte 1417 for cycle 1. Cycle 0 may keep byte 1413 after it is rotated. Cycle 1 may utilize byte 1414, byte 1415, byte 1416, and byte 1417. Cycle 1 may update byte 1414, byte 1415, and byte 1416, as well as combine with byte 1413 from cycle 0. Also, cycle 0 may process a first mask (e.g., mask=0001) to result in level 0 data (L0 rdata) for byte 1413, and cycle 1 may process a second mask (e.g., mask=1110) to result in level 0 data (L0 rdata) for byte 1414, byte 1415, and byte 1416, and combine with byte 1413 from cycle 0. Store process 1406 may update byte 1413 for cycle 0, as well as byte 1413, byte 1414, byte 1415, and byte 1416 for cycle 1. Also, store process 1406 may utilize level 0 data (L0 wdata) for byte 1413, byte 1414, byte 1415, and byte 1416. For instance, cycle 0 may update byte 1413 into the memory after it is rotated, and cycle 1 may update byte 1414, byte 1415, and byte 1416 into the memory after the rotation. Also, cycle 0 may process a third mask (e.g., mask=1000) to result in level 0 data (L0 wdata) for byte 1413, and cycle 1 may process a lowest three-bit mask (e.g., mask=0111) to result in level 0 data (L0 wdata) for byte 1414, byte 1415, and byte 1416. In some aspects, for a cross block case, aspects presented herein may send both starting portions and ending portions of byte. For instance, aspects presented herein may send both starting portions and ending portions of byte in the same cycle for half of a total number of threads. By doing so, this may increase throughput when a portion of the threads are active or a portion of the threads cross block.

Aspects presented herein may increase the GPU performance for a certain number of threads (e.g., up to 16 thread throughput). For example, aspects presented herein may increase the GPU performance for a 16 thread throughput for data size less than or equal to 4 B and address that does not cross block. For example, aspects presented herein may increase the GPU performance for an 8 thread throughput for data size greater than 4 B and less than or equal to 8B and address that does not cross block. For example, aspects presented herein may increase the GPU performance for a 4 thread throughput for data size greater than 8 B and address that does not cross block. Also, when an address does not cross block, aspects presented herein may reduce the thread throughput by a certain amount (e.g., reduce in half). Aspects presented herein may also optimize the timing at a GPU. For example, aspects herein may utilize complex comb logic for coalescing, data layout conversion for different data sizes and address alignments. Also, aspects herein may utilize a well-organized structure help timing and achieve high frequency (e.g., a structure corresponding to logic level 36). Aspects presented herein may also optimize the area at a GPU. For example, multiple threads may coalesce to four 64 B cache lines, and a load throughput may be 64 B/cycle. If a data layout is converted directly, it may utilize 512 mux 256 , which is 3.7 k in 3 nm. With the present approach, it may need 512 mux 64 and 128 4 b rotation, which is 1 k in 3 nm. A GPU may have many such building blocks (e.g., 12 such building blocks in total), which may help save a certain amount of area (e.g., 32.4 k). Additionally, aspects herein may utilize a combinational multiplex reduction in order to save a high amount of power at a GPU.

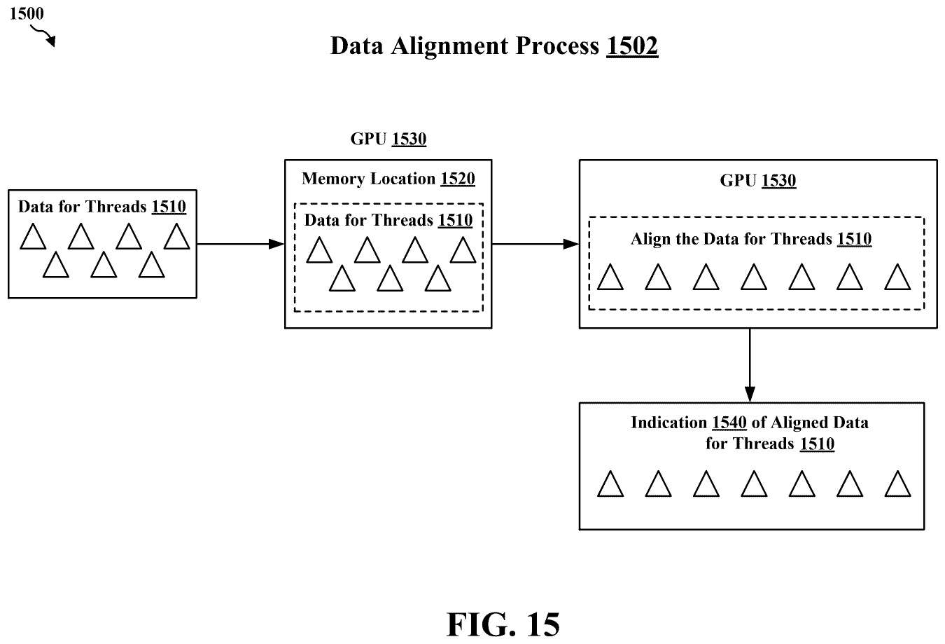

FIG. 15 illustrates diagram 1500 including one example of a data alignment process. More specifically, diagram 1500 depicts a data alignment process 1502 that utilizes the aforementioned data alignment features. As shown in FIG. 15, data alignment process 1502 includes data for threads 1510, memory location 1520, GPU 1530, and indication 1540 of aligned data for threads 1510. GPU 1530 may obtain an indication of data for threads 1510. GPU 1530 may also allocate a memory location 1520 in a plurality of memory locations for data for each of the threads 1510. Moreover, GPU 1530 may align the data for each of the threads 1510 with the allocated memory location 1520 if the data is not aligned with the allocated memory location 1520. Also, GPU 1530 may refrain from aligning the data for each of the threads 1510 with the allocated memory location 1520 if the data is aligned with the allocated memory location 1520. Further, GPU 1530 may output an indication 1540 of the aligned data for each of the threads 1510 or the refrained from aligned data for each of the threads 1510. Additionally, GPU 1530 may coalesce the data for at least one first thread in the threads 1510 and at least one second thread into a same cache line if the address for each cache line for the at least one first thread is equivalent to the address for each cache line for the at least one second thread for each of the plurality of cache banks. Also, GPU 1530 may multiplex the data for each of the threads 1510 between a memory data layout for a plurality of memory locations including memory location 1520 and a thread data layout for each of the threads 1510.

In some instances, aspects herein may unify various data sizes for threads (e.g., up to multiple 4 B blocks). Aspects herein may also map data between threads and memory (e.g., based on 4 B granularity), and then multiplex (mux) the data together. When one thread block maps to two memory blocks, aspects herein may process twice, and operate a portion of the memory block each time. Also, when parallel threads access memory through a cache, aspects herein may coalesce the data for multiple cache lines simultaneously to increase throughput. When parallel threads have a same address, aspects herein may broadcast for read, in order access for write and sequential access for atomic data. Aspects herein may also use a triangular comparison for sequential atomic memory access.

Aspects of the present disclosure may include a number of benefits or advantages. For instance, aspects of the present disclosure may allow GPUs to utilize a large amount of threads in parallel (i.e., at the same time). Aspects presented herein may also provide GPUs with the ability to allow threads to access memory in parallel (i.e., at the same time). Further, aspects presented herein may provide an efficient logic structure within a GPU in order to allow these threads to access memory in parallel (i.e., at the same time). For instance, aspects presented herein may provide an efficient logic structure within a GPU to be able to map these threads-to-memory conversions and to increase storage capabilities. That is, aspects presented herein may efficiently map a number of threads to a memory location or a data access location within the memory location. In order to do so, aspects presented herein may allocate a memory location at a GPU for data for multiple threads. Aspects presented herein may align the data for each of the threads with the allocated memory location if the data is not aligned with the allocated memory location. Also, aspects presented herein may refrain from aligning the data for each of the threads with the allocated memory location if the data is aligned with the allocated memory location. By doing so, aspects presented herein may optimize the performance, timing, area, and power utilized at a GPU. For example, aspects presented herein may increase GPU performance, improve GPU timing, reduce the amount of GPU area utilized, and/or reduce the amount of power utilized at the GPU.

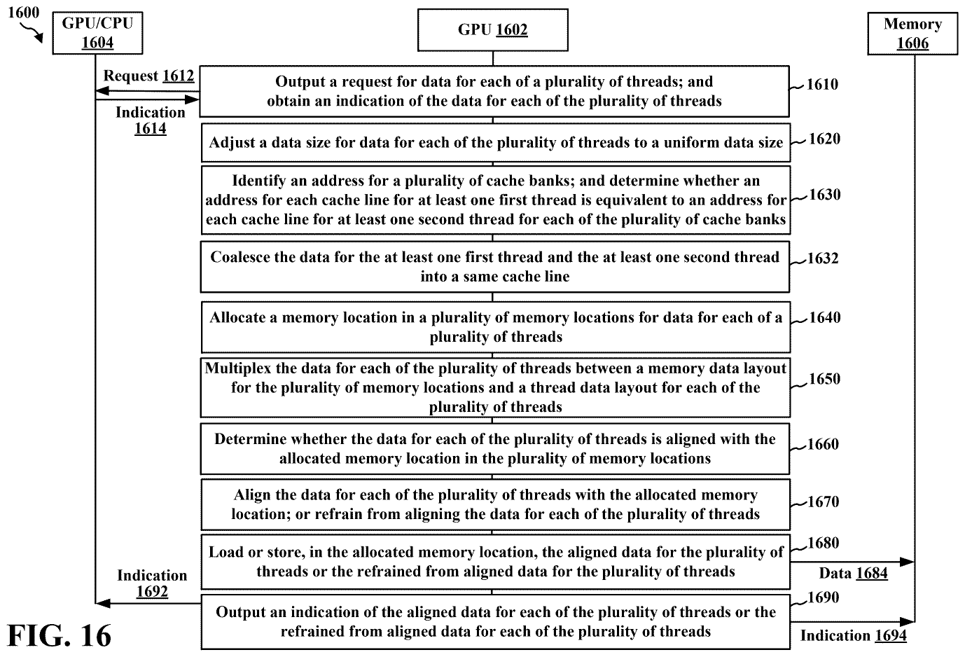

FIG. 16 is a communication flow diagram 1600 of graphics processing in accordance with one or more techniques of this disclosure. As shown in FIG. 16, diagram 1600 includes example communications between GPU 1602 (e.g., a GPU, a GPU component, another graphics processor, a CPU, a CPU component, or another central processor), GPU/CPU 1604 (e.g., a GPU, a GPU component, another graphics processor, a CPU, a CPU component, or another central processor), and memory 1606 (e.g., a memory, a cache, a system memory, a graphics memory, a memory or cache at a CPU, or a memory or cache at a GPU), in accordance with one or more techniques of this disclosure.

At 1610, GPU 1602 may output a request for data for each of a plurality of threads associated with graphics processing, where an allocation of a memory location for the data for each of the plurality of threads is based on the request. For example, GPU 1602 may transmit request 1612 to GPU/CPU 1604. Also, at 1610, GPU 1602 may obtain, based on the request, an indication of the data for each of the plurality of threads, where each of the plurality of threads includes corresponding data. For example, GPU 1602 may receive indication 1614 from GPU/CPU 1604.

At 1620, GPU 1602 may adjust a data size for the data for each of the plurality of threads to a uniform data size, and where allocating a memory location in a plurality of memory locations for the data for each of the plurality of threads may comprise: allocating, based on the uniform data size, the memory location in the plurality of memory locations for the data for each of the plurality of threads.

At 1630, GPU 1602 may identify an address for each of a plurality of cache banks; and determine whether an address for each cache line for at least one first thread in the plurality of threads is equivalent to an address for each cache line for at least one second thread for each of the plurality of cache banks. In some aspects, determining whether the address for each cache line for the at least one first thread in the plurality of threads is equivalent to the address for each cache line for the at least one second thread for each of the plurality of cache banks may comprise: comparing an address for each cache line for the plurality of threads with all prior threads in association with a triangle map. Also, comparing the address for each cache line for the plurality of threads with the all prior threads may comprise: comparing the address for each cache line for the plurality of threads with a plurality of other threads that are prior to the plurality of threads; and generating the triangle map based on a comparison of the address for each cache line for the plurality of threads with the plurality of other threads that are prior to the plurality of threads. Moreover, determining whether the address for each cache line for the at least one first thread in the plurality of threads is equivalent to the address for each cache line for the at least one second thread for each of the plurality of cache banks may comprise: determining whether the address for each cache line for the at least one first thread is equivalent to the address for each cache line for the at least one second thread for each of the plurality of cache banks; determining whether the at least one first thread and the at least one second thread are parallel; and broadcasting, based on the at least one first thread and the at least one second thread being parallel, the data for the at least one first thread and the at least one second thread.

At 1632, GPU 1602 may coalesce the data for the at least one first thread and the at least one second thread into a same cache line if the address for each cache line for the at least one first thread is equivalent to the address for each cache line for the at least one second thread for each of the plurality of cache banks. In some aspects, coalescing the data for the at least one first thread and the at least one second thread into the same cache line may comprise: coalescing, in parallel, the data for the at least one first thread and the at least one second thread into the same cache line.

At 1640, GPU 1602 may allocate a memory location in a plurality of memory locations for data for each of a plurality of threads. In some aspects, allocating the memory location in the plurality of memory locations for the data for each of the plurality of threads may comprise: mapping the data for each of the plurality of threads to the memory location in the plurality of memory locations.

At 1650, GPU 1602 may multiplex the data for each of the plurality of threads between a memory data layout for the plurality of memory locations and a thread data layout for each of the plurality of threads. In some aspects, multiplexing the data for each of the plurality of threads between the memory data layout for the plurality of memory locations and the thread data layout for each of the plurality of threads may comprise: multiplexing, based on a data granularity or a block granularity, the data for each of the plurality of threads between the memory data layout for the plurality of memory locations and the thread data layout for each of the plurality of threads.

At 1660, GPU 1602 may determine, prior to an alignment of the data or a refrainment from alignment of the data, whether the data for each of the plurality of threads is aligned with the allocated memory location in the plurality of memory locations. In some aspects, determining whether the data for each of the plurality of threads is aligned with the allocated memory location in the plurality of memory locations may comprise: determining whether the data for each of the plurality of threads is aligned with a block boundary for a set of blocks for the allocated memory location in the plurality of memory locations.

At 1670, GPU 1602 may align the data for each of the plurality of threads with the allocated memory location if the data is not aligned with the allocated memory location; or refrain from aligning the data for each of the plurality of threads with the allocated memory location if the data is aligned with the allocated memory location. In some aspects, aligning the data for each of the plurality of threads with the allocated memory location may comprise: rotating the data for each of the plurality of threads to align with the allocated memory location. Further, rotating the data for each of the plurality of threads to align with the allocated memory location may comprise: rotating the data for each of the plurality of threads to align with the allocated memory location; and rotating a byte mask for a data block for the data (e.g., a 2 B data block, 4 B data block, 8 B data block, 16 B data block, 32 B data block, and/or 64 B data block) for each of the plurality of threads to align with the allocated memory location. Also, at 1670, GPU 1602 may update, based on the rotated byte mask, each byte in a set of bytes within a data block for the data for each of the plurality of threads, where the data is based on the data block when the data is fetched from, or stored in, the allocated memory location for each thread.

At 1680, GPU 1602 may load or store, in an allocated memory location, the aligned data for each of the plurality of threads or the refrained from aligned data for each of the plurality of threads based on a request for the data for the allocated memory location. For example, GPU 1602 may load or store data 1684 in memory 1606.

At 1690, GPU 1602 may output an indication of the aligned data for each of the plurality of threads or the refrained from aligned data for each of the plurality of threads. In some aspects, outputting the indication of the aligned data or the refrained from aligned data may comprise: transmitting, for each of the plurality of threads, the indication of the aligned data or the refrained from aligned data. For example, GPU 1602 may transmit indication 1692 to GPU/CPU 1604. Also, outputting the indication of the aligned data or the refrained from aligned data may comprise: storing, in a memory, the indication of the aligned data or the refrained from aligned data. For example, GPU 1602 may store indication 1694 in memory 1606.

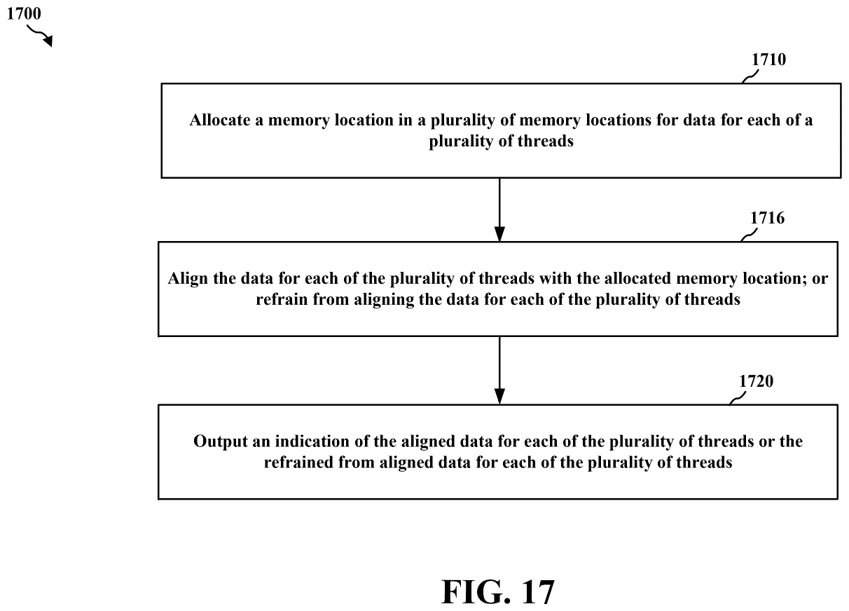

FIG. 17 is a flowchart 1700 of an example method of graphics processing in accordance with one or more techniques of this disclosure. The method may be performed by a GPU (e.g., a GPU, a GPU component, another graphics processor, a CPU, a CPU component, or another central processor), a CPU (e.g., a CPU, a cache at a CPU, a CPU component, another central processor, a GPU, a GPU component, or another graphics processor), a display driver integrated circuit (DDIC), an apparatus for data or graphics processing, a wireless communication device, and/or any apparatus that may perform data or graphics processing as used in connection with the examples of FIGS. 1-16.

At 1710, the GPU may allocate a memory location in a plurality of memory locations for data for each of a plurality of threads, as described in connection with the examples in FIGS. 1-16. For example, as described in 1640 of FIG. 16, GPU 1602 may allocate a memory location in a plurality of memory locations for data for each of a plurality of threads. Further, step 1710 may be performed by processing unit 120 in FIG. 1. In some aspects, allocating the memory location in the plurality of memory locations for the data for each of the plurality of threads may comprise: mapping the data for each of the plurality of threads to the memory location in the plurality of memory locations.

At 1716, the GPU may align the data for each of the plurality of threads with the allocated memory location if the data is not aligned with the allocated memory location; or refrain from aligning the data for each of the plurality of threads with the allocated memory location if the data is aligned with the allocated memory location, as described in connection with the examples in FIGS. 1-16. For example, as described in 1670 of FIG. 16, GPU 1602 may align the data for each of the plurality of threads with the allocated memory location if the data is not aligned with the allocated memory location; or refrain from aligning the data for each of the plurality of threads with the allocated memory location if the data is aligned with the allocated memory location. Further, step 1716 may be performed by processing unit 120 in FIG. 1. In some aspects, aligning the data for each of the plurality of threads with the allocated memory location may comprise: rotating the data for each of the plurality of threads to align with the allocated memory location. Further, rotating the data for each of the plurality of threads to align with the allocated memory location may comprise:
rotating the data for each of the plurality of threads to align with the allocated memory location; and rotating a byte mask for a data block for the data (e.g., a 2 B data block, 4 B data block, 8 B data block, 16 B data block, 32 B data block, and/or 64 B data block) for each of the plurality of threads to align with the allocated memory location. Also, GPU may update, based on the rotated byte mask, each byte in a set of bytes within a data block for the data for each of the plurality of threads, where the data is based on the data block when the data is fetched from, or stored in, the allocated memory location for each thread.

At 1720, the GPU may output an indication of the aligned data for each of the plurality of threads or the refrained from aligned data for each of the plurality of threads, as described in connection with the examples in FIGS. 1-16. For example, as described in 1690 of FIG. 16, GPU 1602 may output an indication of the aligned data for each of the plurality of threads or the refrained from aligned data for each of the plurality of threads. Further, step 1720 may be performed by processing unit 120 in FIG. 1. In some aspects, outputting the indication of the aligned data or the refrained from aligned data may comprise: transmitting, for each of the plurality of threads, the indication of the aligned data or the refrained from aligned data. Also, outputting the indication of the aligned data or the refrained from aligned data may comprise: storing, in a memory, the indication of the aligned data or the refrained from aligned data.

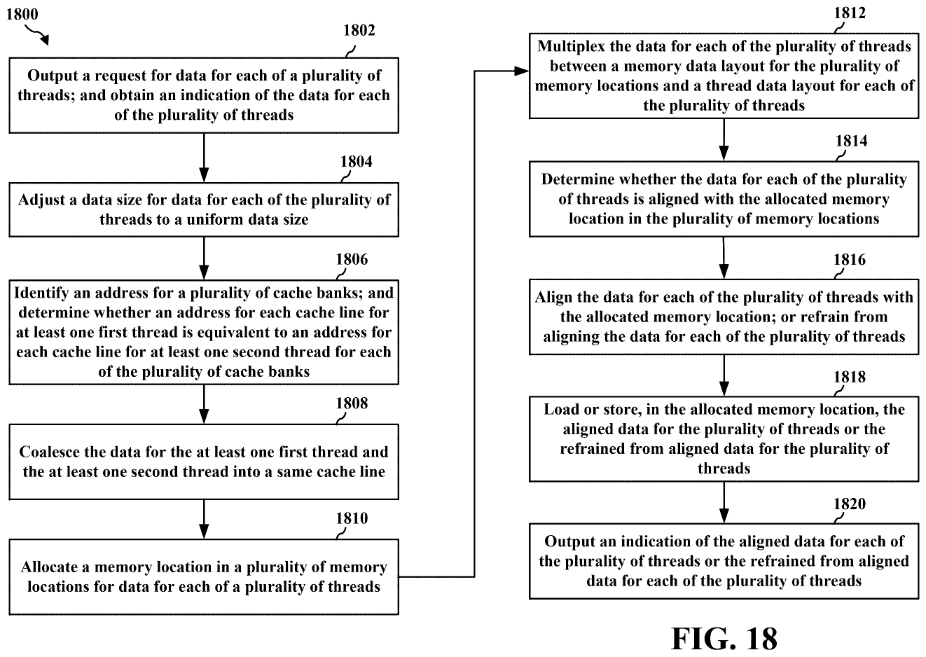

FIG. 18 is a flowchart 1800 of an example method of graphics processing in accordance with one or more techniques of this disclosure. The method may be performed by a GPU (e.g., a GPU, a GPU component, another graphics processor, a CPU, a CPU component, or another central processor), a CPU (e.g., a CPU, a cache at a CPU, a CPU component, another central processor, a GPU, a GPU component, or another graphics processor), a display driver integrated circuit (DDIC), an apparatus for data or graphics processing, a wireless communication device, and/or any apparatus that may perform data or graphics processing as used in connection with the examples of FIGS. 1-16.

At 1802, the GPU may output a request for data for each of a plurality of threads associated with graphics processing, where an allocation of a memory location for the data for each of the plurality of threads is based on the request, as described in connection with the examples in FIGS. 1-16. For example, as described in 1610 of FIG. 16, GPU 1602 may output a request for data for each of a plurality of threads associated with graphics processing, where an allocation of a memory location for the data for each of the plurality of threads is based on the request. Further, step 1802 may be performed by processing unit 120 in FIG. 1. Also, GPU may obtain, based on the request, an indication of the data for each of the plurality of threads, where each of the plurality of threads includes corresponding data.

At 1804, the GPU may adjust a data size for the data for each of the plurality of threads to a uniform data size, and where allocating a memory location in a plurality of memory locations for the data for each of the plurality of threads may comprise: allocating, based on the uniform data size, the memory location in the plurality of memory locations for the data for each of the plurality of threads, as described in connection with the examples in FIGS. 1-16. For example, as described in 1620 of FIG. 16, GPU 1602 may adjust a data size for the data for each of the plurality of threads to a uniform data size, and where allocating a memory location in a plurality of memory locations for the data for each of the plurality of threads may comprise: allocating, based on the uniform data size, the memory location in the plurality of memory locations for the data for each of the plurality of threads. Further, step 1804 may be performed by processing unit 120 in FIG. 1.

At 1806, the GPU may identify an address for each of a plurality of cache banks; and determine whether an address for each cache line for at least one first thread in the plurality of threads is equivalent to an address for each cache line for at least one second thread for each of the plurality of cache banks, as described in connection with the examples in FIGS. 1-16. For example, as described in 1630 of FIG. 16, GPU 1602 may identify an address for each of a plurality of cache banks; and determine whether an address for each cache line for at least one first thread in the plurality of threads is equivalent to an address for each cache line for at least one second thread for each of the plurality of cache banks. Further, step 1806 may be performed by processing unit 120 in FIG. 1. In some aspects, determining whether the address for each cache line for the at least one first thread in the plurality of threads is equivalent to the address for each cache line for the at least one second thread for each of the plurality of cache banks may comprise: comparing an address for each cache line for the plurality of threads with all prior threads in association with a triangle map. Also, comparing the address for each cache line for the plurality of threads with the all prior threads may comprise: comparing the address for each cache line for the plurality of threads with a plurality of other threads that are prior to the plurality of threads; and generating the triangle map based on a comparison of the address for each cache line for the plurality of threads with the plurality of other threads that are prior to the plurality of threads. Moreover, determining whether the address for each cache line for the at least one first thread in the plurality of threads is equivalent to the address for each cache line for the at least one second thread for each of the plurality of cache banks may comprise: determining whether the address for each cache line for the at least one first thread is equivalent to the address for each cache line for the at least one second thread for each of the plurality of cache banks; determining whether the at least one first thread and the at least one second thread are parallel; and broadcasting, based on the at least one first thread and the at least one second thread being parallel, the data for the at least one first thread and the at least one second thread.

At 1808, the GPU may coalesce the data for the at least one first thread and the at least one second thread into a same cache line if the address for each cache line for the at least one first thread is equivalent to the address for each cache line for the at least one second thread for each of the plurality of cache banks, as described in connection with the examples in FIGS. 1-16. For example, as described in 1632 of FIG. 16, GPU 1602 may coalesce the data for the at least one first thread and the at least one second thread into a same cache line if the address for each cache line for the at least one first thread is equivalent to the address for each cache line for the at least one second thread for each of the plurality of cache banks. Further, step 1808 may be performed by processing unit 120 in FIG. 1. In some aspects, coalescing the data for the at least one first thread and the at least one second thread into the same cache line may comprise: coalescing, in parallel, the data for the at least one first thread and the at least one second thread into the same cache line.

At 1810, the GPU may allocate a memory location in a plurality of memory locations for data for each of a plurality of threads, as described in connection with the examples in FIGS. 1-16. For example, as described in 1640 of FIG. 16, GPU 1602 may allocate a memory location in a plurality of memory locations for data for each of a plurality of threads. Further, step 1810 may be performed by processing unit 120 in FIG. 1. In some aspects, allocating the memory location in the plurality of memory locations for the data for each of the plurality of threads may comprise: mapping the data for each of the plurality of threads to the memory location in the plurality of memory locations.

At 1812, the GPU may multiplex the data for each of the plurality of threads between a memory data layout for the plurality of memory locations and a thread data layout for each of the plurality of threads, as described in connection with the examples in FIGS. 1-16. For example, as described in 1650 of FIG. 16, GPU 1602 may multiplex the data for each of the plurality of threads between a memory data layout for the plurality of memory locations and a thread data layout for each of the plurality of threads. Further, step 1812 may be performed by processing unit 120 in FIG. 1. In some aspects, multiplexing the data for each of the plurality of threads between the memory data layout for the plurality of memory locations and the thread data layout for each of the plurality of threads may comprise: multiplexing, based on a data granularity or a block granularity, the data for each of the plurality of threads between the memory data layout for the plurality of memory locations and the thread data layout for each of the plurality of threads.

At 1814, the GPU may determine, prior to an alignment of the data or a refrainment from alignment of the data, whether the data for each of the plurality of threads is aligned with the allocated memory location in the plurality of memory locations, as described in connection with the examples in FIGS. 1-16. For example, as described in 1660 of FIG. 16, GPU 1602 may determine, prior to an alignment of the data or a refrainment from alignment of the data, whether the data for each of the plurality of threads is aligned with the allocated memory location in the plurality of memory locations. Further, step 1814 may be performed by processing unit 120 in FIG. 1. In some aspects, determining whether the data for each of the plurality of threads is aligned with the allocated memory location in the plurality of memory locations may comprise: determining whether the data for each of the plurality of threads is aligned with a block boundary for a set of blocks for the allocated memory location in the plurality of memory locations.

At 1816, the GPU may align the data for each of the plurality of threads with the allocated memory location if the data is not aligned with the allocated memory location; or refrain from aligning the data for each of the plurality of threads with the allocated memory location if the data is aligned with the allocated memory location, as described in connection with the examples in FIGS. 1-16. For example, as described in 1670 of FIG. 16, GPU 1602 may align the data for each of the plurality of threads with the allocated memory location if the data is not aligned with the allocated memory location; or refrain from aligning the data for each of the plurality of threads with the allocated memory location if the data is aligned with the allocated memory location. Further, step 1816 may be performed by processing unit 120 in FIG. 1. In some aspects, aligning the data for each of the plurality of threads with the allocated memory location may comprise: rotating the data for each of the plurality of threads to align with the allocated memory location. Further, rotating the data for each of the plurality of threads to align with the allocated memory location may comprise:
rotating the data for each of the plurality of threads to align with the allocated memory location; and rotating a byte mask for a data block for the data (e.g., a 2 B data block, 4 B data block, 8 B data block, 16 B data block, 32 B data block, and/or 64 B data block) for each of the plurality of threads to align with the allocated memory location. Also, GPU may update, based on the rotated byte mask, each byte in a set of bytes within a data block for the data for each of the plurality of threads, where the data is based on the data block when the data is fetched from, or stored in, the allocated memory location for each thread.

At 1818, the GPU may load or store, in an allocated memory location, the aligned data for each of the plurality of threads or the refrained from aligned data for each of the plurality of threads based on a request for the data for the allocated memory location, as described in connection with the examples in FIGS. 1-16. For example, as described in 1680 of FIG. 16, GPU 1602 may load or store, in an allocated memory location, the aligned data for each of the plurality of threads or the refrained from aligned data for each of the plurality of threads based on a request for the data for the allocated memory location. Further, step 1818 may be performed by processing unit 120 in FIG. 1.

At 1820, the GPU may output an indication of the aligned data for each of the plurality of threads or the refrained from aligned data for each of the plurality of threads, as described in connection with the examples in FIGS. 1-16. For example, as described in 1690 of FIG. 16, GPU 1602 may output an indication of the aligned data for each of the plurality of threads or the refrained from aligned data for each of the plurality of threads. Further, step 1820 may be performed by processing unit 120 in FIG. 1. In some aspects, outputting the indication of the aligned data or the refrained from aligned data may comprise: transmitting, for each of the plurality of threads, the indication of the aligned data or the refrained from aligned data. Also, outputting the indication of the aligned data or the refrained from aligned data may comprise: storing, in a memory, the indication of the aligned data or the refrained from aligned data.

In configurations, a method or an apparatus for data or graphics processing is provided. The apparatus may be a GPU (or other graphics processor), a CPU (or other central processor), a DDIC, an apparatus for graphics processing, and/or some other processor that may perform data or graphics processing. In aspects, the apparatus may be the processing unit 120 within the device 104, or may be some other hardware within the device 104 or another device. The apparatus, e.g., processing unit 120, may include means for allocating a memory location in a plurality of memory locations for data for each of a plurality of threads. The apparatus, e.g., processing unit 120, may also include means for aligning the data for each of the plurality of threads with the allocated memory location if the data is not aligned with the allocated memory location; or refraining from aligning the data for each of the plurality of threads with the allocated memory location if the data is aligned with the allocated memory location. The apparatus, e.g., processing unit 120, may also include means for outputting an indication of the aligned data for each of the plurality of threads or the refrained from aligned data for each of the plurality of threads. The apparatus, e.g., processing unit 120, may also include means for identifying an address for each of a plurality of cache banks; and means for determining whether an address for each cache line for at least one first thread in the plurality of threads is equivalent to an address for each cache line for at least one second thread for each of the plurality of cache banks. The apparatus, e.g., processing unit 120, may also include means for coalescing the data for the at least one first thread and the at least one second thread into a same cache line if the address for each cache line for the at least one first thread is equivalent to the address for each cache line for the at least one second thread for each of the plurality of cache banks. The apparatus, e.g., processing unit 120, may also include means for updating, based on the rotated byte mask, each byte in a set of bytes within the data block for the data for each of the plurality of threads. The apparatus, e.g., processing unit 120, may also include means for multiplexing the data for each of the plurality of threads between a memory data layout for the plurality of memory locations and a thread data layout for each of the plurality of threads. The apparatus, e.g., processing unit 120, may also include means for determining, prior to the alignment of the data or the refrainment from alignment of the data, whether the data for each of the plurality of threads is aligned with the allocated memory location in the plurality of memory locations. The apparatus, e.g., processing unit 120, may also include means for loading or storing, in the allocated memory location, the aligned data for each of the plurality of threads or the refrained from aligned data for each of the plurality of threads based on a request for the data for the allocated memory location. The apparatus, e.g., processing unit 120, may also include means for adjusting a data size for the data for each of the plurality of threads to a uniform data size, and where allocating the memory location in the plurality of memory locations for the data for each of the plurality of threads comprises: allocating, based on the uniform data size, the memory location in the plurality of memory locations for the data for each of the plurality of threads. The apparatus, e.g., processing unit 120, may also include means for outputting a request for the data for each of the plurality of threads associated with the graphics processing, where the allocation of the memory location for the data for each of the plurality of threads is based on the request. The apparatus, e.g., processing unit 120, may also include means for obtaining, based on the request, an indication of the data for each of the plurality of threads, where each of the plurality of threads includes corresponding data.

The subject matter described herein may be implemented to realize one or more benefits or advantages. For instance, the described graphics processing techniques may be used by a GPU, a CPU, a central processor, or some other processor that may perform graphics processing to implement the alignment techniques described herein. This may also be accomplished at a low cost compared to other graphics processing techniques. Moreover, the graphics processing techniques herein may improve or speed up graphics processing or execution. Further, the graphics processing techniques herein may improve resource or data utilization and/or resource efficiency. Additionally, aspects of the present disclosure may utilize alignment techniques in order to improve memory bandwidth efficiency and/or increase processing speed at a GPU, a CPU, or a DPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including at least one memory and at least one processor coupled to the at least one memory and, based at least in part on information stored in the at least one memory, the at least one processor, individually or in any combination, is configured to: allocate a memory location in a plurality of memory locations for data for each of a plurality of threads; align the data for each of the plurality of threads with the allocated memory location if the data is not aligned with the allocated memory location; or refrain from aligning the data for each of the plurality of threads with the allocated memory location if the data is aligned with the allocated memory location; and output an indication of the aligned data for each of the plurality of threads or the refrained from aligned data for each of the plurality of threads.

Aspect 2 is the apparatus of aspect 1, wherein the at least one processor is further configured to: identify an address for each of a plurality of cache banks; and determine whether an address for each cache line for at least one first thread in the plurality of threads is equivalent to an address for each cache line for at least one second thread for each of the plurality of cache banks.

Aspect 3 is the apparatus of aspect 2, wherein the at least one processor is further configured to: coalesce the data for the at least one first thread and the at least one second thread into a same cache line if the address for each cache line for the at least one first thread is equivalent to the address for each cache line for the at least one second thread for each of the plurality of cache banks.

Aspect 4 is the apparatus of aspect 3, wherein to coalesce the data for the at least one first thread and the at least one second thread into the same cache line, the at least one processor is configured to: coalesce, in parallel, the data for the at least one first thread and the at least one second thread into the same cache line.

Aspect 5 is the apparatus of any of aspects 2 to 4, wherein to determine whether the address for each cache line for the at least one first thread in the plurality of threads is equivalent to the address for each cache line for the at least one second thread for each of the plurality of cache banks, the at least one processor is configured to: compare an address for each cache line for the plurality of threads with all prior threads in association with a triangle map.

Aspect 6 is the apparatus of aspect 5, wherein to compare the address for each cache line for the plurality of threads with the all prior threads, the at least one processor is configured to: compare the address for each cache line for the plurality of threads with a plurality of other threads that are prior to the plurality of threads; and generate the triangle map based on a comparison of the address for each cache line for the plurality of threads with the plurality of other threads that are prior to the plurality of threads.

Aspect 7 is the apparatus of any of aspects 2 to 6, wherein to determine whether the address for each cache line for the at least one first thread in the plurality of threads is equivalent to the address for each cache line for the at least one second thread for each of the plurality of cache banks, the at least one processor is configured to: determine whether the address for each cache line for the at least one first thread is equivalent to the address for each cache line for the at least one second thread for each of the plurality of cache banks; determine whether the at least one first thread and the at least one second thread are parallel; and broadcast, based on the at least one first thread and the at least one second thread being parallel, the data for the at least one first thread and the at least one second thread.

Aspect 8 is the apparatus of any of aspects 1 to 7, wherein to align the data for each of the plurality of threads with the allocated memory location, the at least one processor is configured to: rotate the data for each of the plurality of threads to align with the allocated memory location.

Aspect 9 is the apparatus of aspect 8, wherein to rotate the data for each of the plurality of threads to align with the allocated memory location, the at least one processor is configured to: rotate the data for each of the plurality of threads to align with the allocated memory location; and rotate a byte mask for a data block for the data (e.g., a 2 B data block, 4 B data block, 8 B data block, 16 B data block, 32 B data block, and/or 64B data block) for each of the plurality of threads to align with the allocated memory location.

Aspect 10 is the apparatus of aspect 9, wherein the at least one processor is further configured to: update, based on the rotated byte mask, each byte in a set of bytes within the data block for the data for each of the plurality of threads, wherein the data is based on the data block when the data is fetched from, or stored in, the allocated memory location for each thread.

Aspect 11 is the apparatus of any of aspects 1 to 10, wherein the at least one processor is further configured to: multiplex the data for each of the plurality of threads between a memory data layout for the plurality of memory locations and a thread data layout for each of the plurality of threads.

Aspect 12 is the apparatus of aspect 11, wherein to multiplex the data for each of the plurality of threads between the memory data layout for the plurality of memory locations and the thread data layout for each of the plurality of threads, the at least one processor is configured to: multiplex, based on a data granularity or a block granularity, the data for each of the plurality of threads between the memory data layout for the plurality of memory locations and the thread data layout for each of the plurality of threads.

Aspect 13 is the apparatus of any of aspects 1 to 12, wherein to allocate the memory location in the plurality of memory locations for the data for each of the plurality of threads, the at least one processor is configured to: map the data for each of the plurality of threads to the memory location in the plurality of memory locations.

Aspect 14 is the apparatus of any of aspects 1 to 13, wherein the at least one processor is further configured to: determine, prior to the alignment of the data or the refrainment from alignment of the data, whether the data for each of the plurality of threads is aligned with the allocated memory location in the plurality of memory locations.

Aspect 15 is the apparatus of aspect 14, wherein to determine whether the data for each of the plurality of threads is aligned with the allocated memory location in the plurality of memory locations, the at least one processor is configured to: determine whether the data for each of the plurality of threads is aligned with a block boundary for a set of blocks for the allocated memory location in the plurality of memory locations.

Aspect 16 is the apparatus of any of aspects 1 to 15, wherein the at least one processor is further configured to: load or store, in the allocated memory location, the aligned data for each of the plurality of threads or the refrained from aligned data for each of the plurality of threads based on a request for the data for the allocated memory location.

Aspect 17 is the apparatus of any of aspects 1 to 16, wherein the at least one processor is further configured to: adjust a data size for the data for each of the plurality of threads to a uniform data size, and wherein to allocate the memory location in the plurality of memory locations for the data for each of the plurality of threads, the at least one processor is configured to: allocate, based on the uniform data size, the memory location in the plurality of memory locations for the data for each of the plurality of threads.

Aspect 18 is the apparatus of any of aspects 1 to 17, wherein the at least one processor is further configured to: output a request for the data for each of the plurality of threads associated with the graphics processing, wherein the allocation of the memory location for the data for each of the plurality of threads is based on the request.

Aspect 19 is the apparatus of aspect 18, wherein the at least one processor is further configured to: obtain, based on the request, an indication of the data for each of the plurality of threads, wherein each of the plurality of threads includes corresponding data.

Aspect 20 is the apparatus of any of aspects 1 to 19, wherein to output the indication of the aligned data or the refrained from aligned data, the at least one processor is configured to: transmit, for each of the plurality of threads, the indication of the aligned data or the refrained from aligned data; or store, in a memory, the indication of the aligned data or the refrained from aligned data.

Aspect 21 is the apparatus of aspect 20, further including (i.e., comprising) at least one of an antenna or a transceiver coupled to the at least one processor, wherein to transmit the indication of the aligned data or the refrained from aligned data, the at least one processor is configured to: transmit, via at least one of an antenna or a transceiver, the indication of the aligned data or the refrained from aligned data.

Aspect 22 is the apparatus of any of aspects 1 to 21, wherein the apparatus is a wireless communication device.

Aspect 23 is a method of graphics processing for implementing any of aspects 1 to 21.

Aspect 24 is an apparatus for graphics processing including means for implementing any of aspects 1 to 21.

Aspect 25 is a computer-readable medium (e.g., a non-transitory computer-readable medium) storing computer executable code (e.g., code for graphics processing), the code when executed by at least one processor causes the at least one processor to implement any of aspects 1 to 21.

What is claimed is:

1. An apparatus for graphics processing, comprising:
at least one memory; and
at least one processor coupled to the at least one memory and, based at least in part on information stored in the at least one memory, the at least one processor is configured to:
allocate a memory location in a plurality of memory locations for data for each of a plurality of threads;
align the data for each of the plurality of threads with the allocated memory location if the data is not aligned with the allocated memory location; or refrain from aligning the data for each of the plurality of threads with the allocated memory location if the data is aligned with the allocated memory location; and
output an indication of the aligned data for each of the plurality of threads or the refrained from aligned data for each of the plurality of threads.

2. The apparatus of claim 1, wherein the at least one processor is further configured to:
identify an address for each of a plurality of cache banks; and
determine whether an address for each cache line for at least one first thread in the plurality of threads is equivalent to an address for each cache line for at least one second thread for each of the plurality of cache banks.

3. The apparatus of claim 2, wherein the at least one processor is further configured to:
coalesce the data for the at least one first thread and the at least one second thread into a same cache line if the address for each cache line for the at least one first thread is equivalent to the address for each cache line for the at least one second thread for each of the plurality of cache banks.

4. The apparatus of claim 3, wherein to coalesce the data for the at least one first thread and the at least one second thread into the same cache line, the at least one processor is configured to:
coalesce, in parallel, the data for the at least one first thread and the at least one second thread into the same cache line.

5. The apparatus of claim 2, wherein to determine whether the address for each cache line for the at least one first thread in the plurality of threads is equivalent to the address for each cache line for the at least one second thread for each of the plurality of cache banks, the at least one processor is configured to:
compare an address for each cache line for the plurality of threads with all prior threads in association with a triangle map.

6. The apparatus of claim 5, wherein to compare the address for each cache line for the plurality of threads with the all prior threads, the at least one processor is configured to:
compare the address for each cache line for the plurality of threads with a plurality of other threads that are prior to the plurality of threads; and
generate the triangle map based on a comparison of the address for each cache line for the plurality of threads with the plurality of other threads that are prior to the plurality of threads.

7. The apparatus of claim 2, wherein to determine whether the address for each cache line for the at least one first thread in the plurality of threads is equivalent to the address for each cache line for the at least one second thread for each of the plurality of cache banks, the at least one processor is configured to:
determine whether the address for each cache line for the at least one first thread is equivalent to the address for each cache line for the at least one second thread for each of the plurality of cache banks;
determine whether the at least one first thread and the at least one second thread are parallel; and
broadcast, based on the at least one first thread and the at least one second thread being parallel, the data for the at least one first thread and the at least one second thread.

8. The apparatus of claim 1, wherein to align the data for each of the plurality of threads with the allocated memory location, the at least one processor is configured to:
rotate the data for each of the plurality of threads to align with the allocated memory location.

9. The apparatus of claim 8, wherein to rotate the data for each of the plurality of threads to align with the allocated memory location, the at least one processor is configured to:
rotate the data for each of the plurality of threads to align with the allocated memory location; and
rotate a byte mask for a data block for the data for each of the plurality of threads to align with the allocated memory location.

10. The apparatus of claim 9, wherein the at least one processor is further configured to:
update, based on the rotated byte mask, each byte in a set of bytes within the data block for the data for each of the plurality of threads, wherein the data is based on the data block when the data is fetched from, or stored in, the allocated memory location for each thread.

11. The apparatus of claim 1, wherein the at least one processor is further configured to:
multiplex the data for each of the plurality of threads between a memory data layout for the plurality of memory locations and a thread data layout for each of the plurality of threads.

12. The apparatus of claim 11, wherein to multiplex the data for each of the plurality of threads between the memory data layout for the plurality of memory locations and the thread data layout for each of the plurality of threads, the at least one processor is configured to:
multiplex, based on a data granularity or a block granularity, the data for each of the plurality of threads between the memory data layout for the plurality of memory locations and the thread data layout for each of the plurality of threads.

13. The apparatus of claim 1, wherein to allocate the memory location in the plurality of memory locations for the data for each of the plurality of threads, the at least one processor is configured to:
map the data for each of the plurality of threads to the memory location in the plurality of memory locations.

14. The apparatus of claim 1, wherein the at least one processor is further configured to:
determine, prior to the alignment of the data or the refrainment from alignment of the data, whether the data for each of the plurality of threads is aligned with the allocated memory location in the plurality of memory locations.

15. The apparatus of claim 14, wherein to determine whether the data for each of the plurality of threads is aligned with the allocated memory location in the plurality of memory locations, the at least one processor is configured to:
determine whether the data for each of the plurality of threads is aligned with a block boundary for a set of blocks for the allocated memory location in the plurality of memory locations.

16. The apparatus of claim 1, wherein the at least one processor is further configured to:
load or store, in the allocated memory location, the aligned data for each of the plurality of threads or the refrained from aligned data for each of the plurality of threads based on a request for the data for the allocated memory location.

17. The apparatus of claim 1, wherein the at least one processor is further configured to:
adjust a data size for the data for each of the plurality of threads to a uniform data size, and wherein to allocate the memory location in the plurality of memory locations for the data for each of the plurality of threads, the at least one processor is configured to: allocate, based on the uniform data size, the memory location in the plurality of memory locations for the data for each of the plurality of threads.

18. The apparatus of claim 1, wherein the at least one processor is further configured to:
output a request for the data for each of the plurality of threads associated with the graphics processing, wherein the allocation of the memory location for the data for each of the plurality of threads is based on the request; and
obtain, based on the request, an indication of the data for each of the plurality of threads, wherein each of the plurality of threads includes corresponding data.

19. A method of graphics processing, comprising:
allocating a memory location in a plurality of memory locations for data for each of a plurality of threads;
aligning the data for each of the plurality of threads with the allocated memory location if the data is not aligned with the allocated memory location; or refraining from aligning the data for each of the plurality of threads with the allocated memory location if the data is aligned with the allocated memory location; and
outputting an indication of the aligned data for each of the plurality of threads or the refrained from aligned data for each of the plurality of threads.

20. A computer-readable medium storing computer executable code for graphics processing, the code when executed by at least one processor causes the at least one processor to:
allocate a memory location in a plurality of memory locations for data for each of a plurality of threads;
align the data for each of the plurality of threads with the allocated memory location if the data is not aligned with the allocated memory location; or refrain from aligning the data for each of the plurality of threads with the allocated memory location if the data is aligned with the allocated memory location; and
output an indication of the aligned data for each of the plurality of threads or the refrained from aligned data for each of the plurality of threads.
